(19) United States
(12) Patent Application Publication
(10) Pub. No.: US 2026/0037293 A1
(43) Pub. Date: Feb. 5, 2026

(54) MIGRATION AND DISASTER RECOVERY OF VTPM ENABLED VIRTUAL MACHINES

(71) Applicant: NUTANIX, INC., San Jose, CA (US)

(72) Inventors: Amir EIBAGI, San Diego, CA (US); Mayank TYAGI, Bengaluru (IN); Naveen KUMAR, Bengaluru (IN); Sandeep GHADAGE, Sangli (IN); Sudish SAH, Bengaluru (IN)

(21) Appl. No.: 18/984,668

(22) Filed: Dec. 17, 2024

Related U.S. Application Data
(60) Provisional application No. 63/688,764, filed on Aug. 29, 2024.

(30) Foreign Application Priority Data
Jul. 31, 2024 (IN) 202441057988

(51) Int. Cl. G06F 9/455; H04L 9/08

(52) U.S. Cl. CPC G06F 9/45558; H04L 9/0819; H04L 9/0877; G06F 2009/4557

(57) ABSTRACT

Techniques for migration or disaster recovery of vTPM enabled virtual machines include non-transitory computer-readable media storing program instructions that, when executed by one or more processors associated with a computing device, cause the one or more processors to perform a method including transmitting, by a primary site, an encryption secret for an encrypted storage device to a secondary site, the encrypted storage device storing data encrypted based on the encryption secret; and transmitting, by the primary site using an unsecure channel, the data as encrypted based on the encryption secret to the secondary site.

### CROSS-REFERENCE TO RELATED APPLICATIONS

This application claims the benefit of Indian Provisional Patent application entitled “DISASTER RECOVERY OF VTPM ENABLED VIRTUAL MACHINES,” filed Jul. 31, 2024, and having Ser. No. 20/244,1057988. This application further claims the benefit of U.S. Provisional Patent Application No. 63/688,764 entitled “DISASTER RECOVERY OF VTPM ENABLED VIRTUAL MACHINES,” filed Aug. 29, 2024. The subject matter of these related applications is hereby incorporated herein by reference.

### BACKGROUND

### Field of the Various Embodiments

Embodiments of the present invention relate generally to disaster recovery technologies, and more specifically, migration and disaster recovery of virtual trusted platform module (vTPM) enabled virtual machines.

### DESCRIPTION OF THE RELATED ART

A vTPM provides cryptographic operations in software similar to how a trusted platform module (TPM) provides similar capabilities in a hardware device. Security critical applications utilized by virtual machines (VMs) utilize a vTPM. These applications include volume encryption, such as BitLocker, secure boot, and/or measured boot. The applications utilize a vTPM to securely store data and perform cryptographic operations. The encryption secrets used to encrypt and decrypt the securely stored data are often managed using a centralized secure store or key store. However, in a disaster recovery scenario where a centralized secure store is not available between different computing environments, migrating virtual machines that rely upon vTPM operations and vTPM secured data from a first environment to a second environment can be difficult. Performing disaster recovery operations such as replication, snapshotting, or restoring from backup without creating cryptographic dependencies between disaster recovery sites and affecting performance is a challenge.

In addition, many computing environments don't include a centralized secure store and instead use local secure stores. In such scenarios, the encryption secrets cannot be shared directly between the first and second environments because the keys for accessing the encryption secrets used by the local secure store of the first environment are not known to the local secure store of the second environment.

For example, in the case of an encrypted volume, such as a BitLocker volume, migrating the volume from a first environment to a second environment can prove to be computationally expensive. In one approach, all of the data on the encrypted volume can be decrypted using keys scored in the vTPM in the first environment and then re-encrypted for secure transfer to the second environment and then decrypted and re-encrypted at the second environment using another vTPM associated with the second environment. This approach consumes a significant amount of computing resources at both ends for both the encrypting and decrypting operations.

What is needed in the art is an efficient approach that allows vTPMs or other types of computing services in a second environment to access data that is encrypted using a vTPM or other types of encryption secrets in a first environment.

### SUMMARY

The disclosed embodiments describe techniques for enabling replication or migration of an encrypted storage device with an associated encryption secret when only local key stores are used.

In various embodiments, a method includes securely transmitting, by a primary site, an encryption secret for an encrypted storage device to a secondary site, the encrypted storage device storing data encrypted based on the encryption secret. The method further includes transmitting, by the primary site using an unsecure channel, the data as encrypted based on the encryption secret to the secondary site.

Further embodiments provide, among other things, methods and systems for implementing one or more aspects of the disclosed techniques.

At least one technical advantage of the disclosed techniques relative to prior art is that, with the disclosed techniques, VMs or disk volumes associated with VMs need not be decrypted and re-encrypted for secure migration or replication, which reduces the consumption of processing resources to perform migration or disaster recovery. Additionally, a centralized secure store or centralized key store is not required to allow for different environments to access the encrypted disk volume or VM. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIGS. 1A-1D are block diagrams illustrating virtualization system architectures configured to implement one or more aspects of the present embodiments; and

FIG. 2 is a block diagram illustrating a networked environment in which one or more aspects of the present embodiments are implemented.

FIG. 3 is a block diagram illustrating how a source computing environment and destination computing environment replicate and recover an encrypted storage device and encryption secret, according to one or more aspects of the present embodiments.

FIG. 4 is a block diagram illustrating how a source computing environment and destination computing environment synchronize an encrypted storage device and encryption secret, according to one or more aspects of the present embodiments.

FIG. 5 is a block diagram illustrating how a source computing environment and destination computing environment recover an encrypted storage device, according to one or more aspects of the present embodiments.

FIG. 6 is a flow diagram illustrating an example method for storing an encrypted encryption secret in a database, according to one or more aspects of the present embodiments.

FIG. 7 is a flow diagram illustrating an example method for providing an encrypted encryption secret to a recovery service, according to one or more aspects of the present embodiments.

FIG. 8 is a flow diagram illustrating an example method for securely transmitting encryption data and data from an encrypted storage device to a destination computing environment, according to one or more aspects of the present embodiments.

FIG. 9 is a flow diagram illustrating an example method for receiving data from an encrypted storage device at a destination computing environment, according to one or more aspects of the present embodiments.

FIG. 10 is a flow diagram illustrating an example method for recovering a VM having an encrypted storage device in a destination computing environment, according to one or more aspects of the present embodiments.

FIG. 11 is a flow diagram illustrating an example method for transmitting an encryption secret from a source computing environment to a destination computing environment, according to one or more aspects of the present embodiments.

FIG. 12 is a flow diagram illustrating an example method for receiving an encryption secret from a source computing environment at a destination computing environment, according to one or more aspects of the present embodiments.

FIG. 13 is a flow diagram illustrating an example method for recovering an encrypted storage device in a destination computing environment, according to one or more aspects of the present embodiments.

### DETAILED DESCRIPTION

In the following description, various concepts and examples are disclosed that provide more effective techniques for accessing business data using executable code included in authorization identifiers. The numerous specific details set forth will provide artisans with a more thorough understanding of the various embodiments. However, it will be apparent to one skilled in the art that the inventive concepts can be practiced without one or more of these specific details.

### Exemplary Virtualization System Architectures

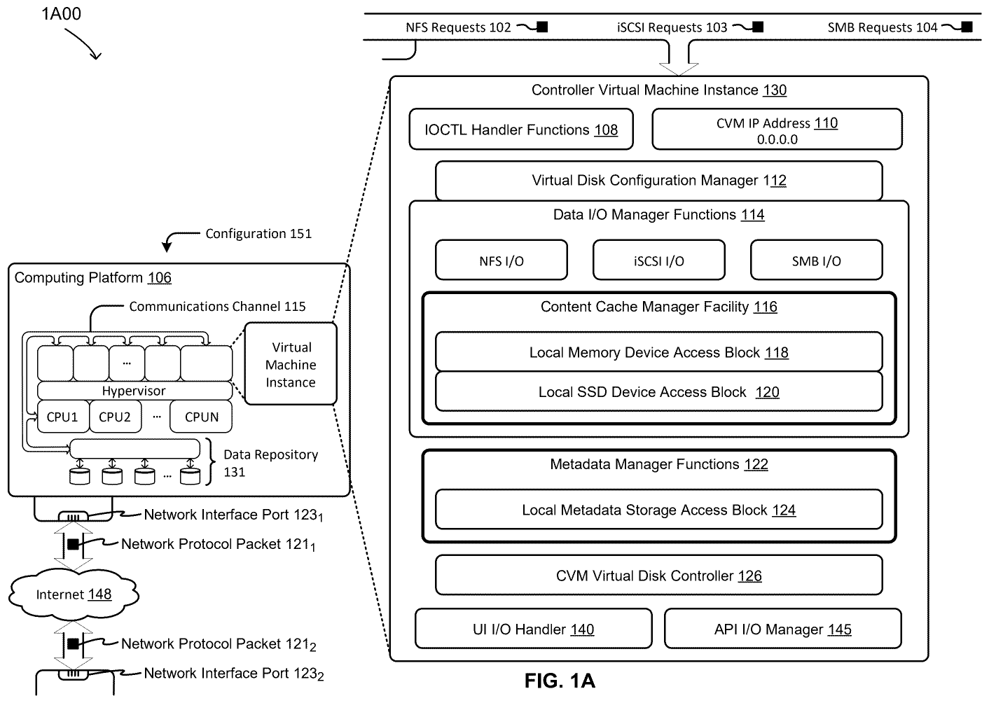

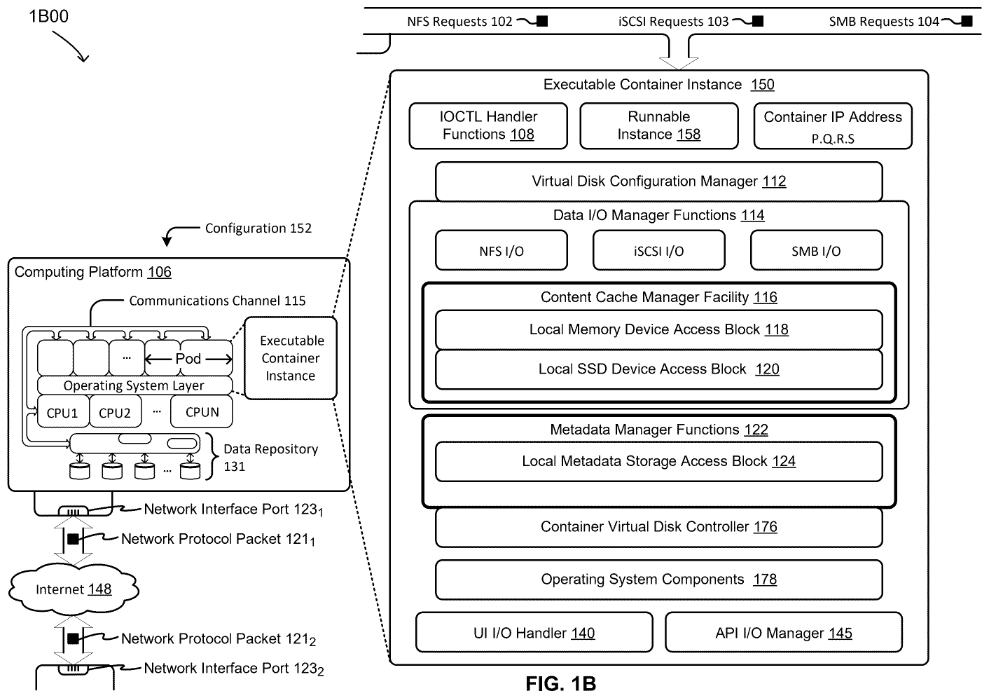

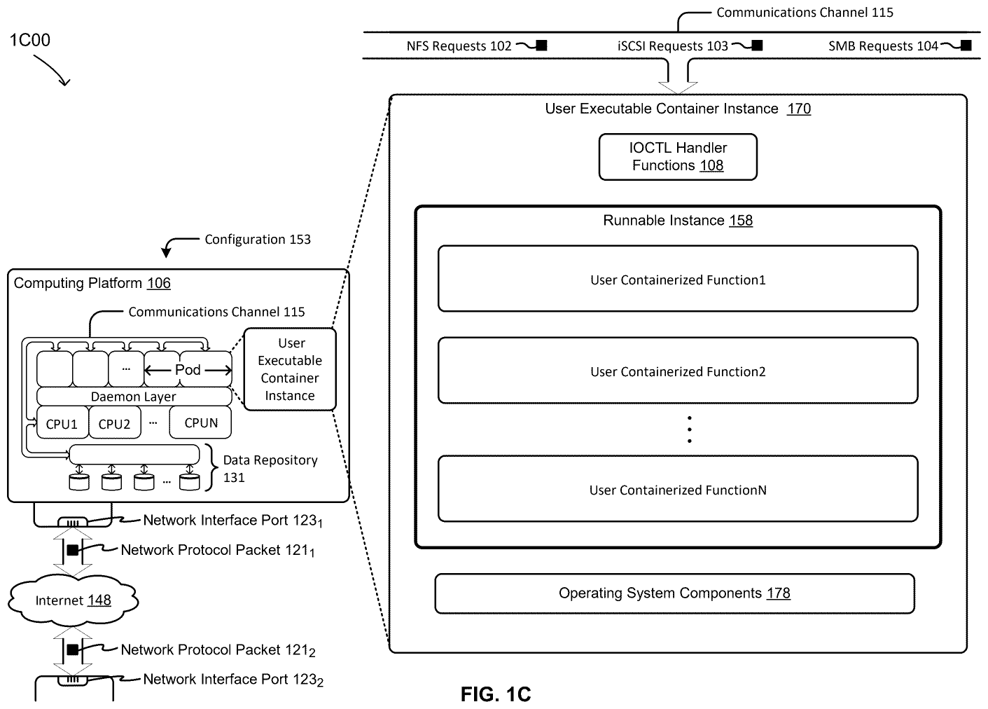

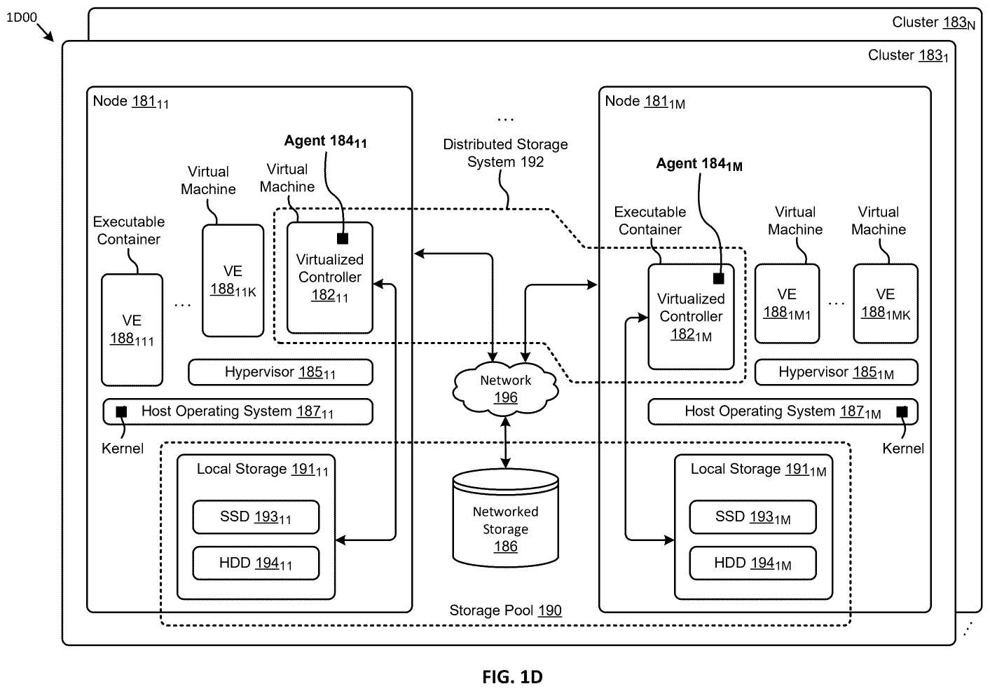

According to some embodiments, all or portions of any of the disclosed techniques can be partitioned into one or more modules and instances within, or as, or in conjunction with a virtualized controller in a virtual computing environment. Some example instances within various virtual computing environments are shown and discussed in further detail in FIGS. 1A-1D. Consistent with these embodiments, a virtualized controller includes a collection of software instructions that serve to abstract details of underlying hardware or software components from one or more higher-level processing entities. In some embodiments, a virtualized controller can be implemented as a virtual machine, as an executable container, or within a layer (e.g., such as a layer in a hypervisor). Consistent with these embodiments, distributed systems include collections of interconnected components that are designed for, or dedicated to, storage operations as well as being designed for, or dedicated to, computing and/or networking operations.

In some embodiments, interconnected components in a distributed system can operate cooperatively to achieve a particular objective such as to provide high-performance computing, high-performance networking capabilities, and/or high-performance storage and/or high-capacity storage capabilities. For example, a first set of components of a distributed computing system can coordinate to efficiently use a set of computational or compute resources, while a second set of components of the same distributed computing system can coordinate to efficiently use the same or a different set of data storage facilities.

In some embodiments, a hyperconverged system coordinates the efficient use of compute and storage resources by and between the components of the distributed system. Adding a hyperconverged unit to a hyperconverged system expands the system in multiple dimensions. As an example, adding a hyperconverged unit to a hyperconverged system can expand the system in the dimension of storage capacity while concurrently expanding the system in the dimension of computing capacity and also in the dimension of networking bandwidth. Components of any of the foregoing distributed systems can comprise physically and/or logically distributed autonomous entities.

In some embodiments, physical and/or logical collections of such autonomous entities can sometimes be referred to as nodes. In some hyperconverged systems, compute and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as executable containers. In some systems and/or environments, hypervisor-assisted virtualization techniques and operating system virtualization techniques are combined.

FIG. 1A is a block diagram illustrating virtualization system architecture 1A00 configured to implement one or more aspects of the present embodiments. As shown in FIG. 1A, virtualization system architecture 1A00 includes a collection of interconnected components, including a controller virtual machine (CVM) instance 130 in a configuration 151. Configuration 151 includes a computing platform 106 that supports virtual machine instances that are deployed as user virtual machines, or controller virtual machines or both. Such virtual machines interface with a hypervisor (as shown). In some examples, virtual machines can include processing of storage I/O (input/output or IO) as received from any or every source within the computing platform. An example implementation of such a virtual machine that processes storage I/O is depicted as CVM instance 130.

In this and other configurations, a CVM instance receives block I/O storage requests as network file system (NFS) requests in the form of NFS requests 102, internet small computer storage interface (iSCSI) block IO requests in the form of iSCSI requests 103, Samba file system (SMB) requests in the form of SMB requests 104, and/or the like. The CVM instance publishes and responds to an internet protocol (IP) address (e.g., CVM IP address 110). Various forms of input and output can be handled by one or more IO control handler functions (e.g., IOCTL handler functions 108) that interface to other functions such as data IO manager functions 114 and/or metadata manager functions 122. As shown, the data IO manager functions can include communication with virtual disk configuration manager 112 and/or can include direct or indirect communication with any of various block IO functions (e.g., NFS IO, ISCSI IO, SMB IO, etc.).

In addition to block IO functions, configuration 151 supports IO of any form (e.g., block IO, streaming IO, packet-based IO, HTTP traffic, etc.) through either or both of a user interface (UI) handler such as UI IO handler 140 and/or through any of a range of application programming interfaces (APIs), possibly through API IO manager 145.

Communications link 115 can be configured to transmit (e.g., send, receive, signal, etc.) any type of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), formatting of bit fields into fixed-length blocks or into variable length fields used to populate the payload, and/or the like. In some cases, packet characteristics include a version identifier, a packet or payload length, a traffic class, a flow label, etc. In some cases, the payload comprises a data structure that is encoded and/or formatted to fit into byte or word boundaries of the packet.

In some embodiments, hard-wired circuitry can be used in place of, or in combination with, software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

Computing platform 106 includes one or more computer readable media that is capable of providing instructions to a data processor for execution. In some examples, each of the computer readable media can take many forms including, but not limited to, non-volatile media and volatile media. Non-volatile media includes any non-volatile storage medium, for example, solid state storage devices (SSDs) or optical or magnetic disks such as hard disk drives (HDDs) or hybrid disk drives, or random-access persistent memories (RAPMs) or optical or magnetic media drives such as paper tape or magnetic tape drives. Volatile media includes dynamic memory such as random-access memory (RAM). As shown, controller virtual machine instance 130 includes content cache manager facility 116 that accesses storage locations, possibly including local dynamic random-access memory (DRAM) (e.g., through local memory device access block 118) and/or possibly including accesses to local solid-state storage (e.g., through local SSD device access block 120).

Common forms of computer readable media include any non-transitory computer readable medium, for example, floppy disk, flexible disk, hard disk, magnetic tape, or any other magnetic medium; CD-ROM or any other optical medium; punch cards, paper tape, or any other physical medium with patterns of holes; or any RAM, PROM, EPROM, FLASH-EPROM, or any other memory chip or cartridge. Any data can be stored, for example, in any form of data repository 131, which in turn can be formatted into any one or more storage areas, and which can comprise parameterized storage accessible by a key (e.g., a filename, a table name, a block address, an offset address, etc.). Data repository 131 can store any forms of data and can comprise a storage area dedicated to storage of metadata pertaining to the stored forms of data. In some cases, metadata can be divided into portions. Such portions and/or cache copies can be stored in the storage data repository and/or in a local storage area (e.g., in local DRAM areas and/or in local SSD areas). Such local storage can be accessed using functions provided by local metadata storage access block 124. The data repository 131 can be configured using CVM virtual disk controller 126, which can in turn manage any number or any configuration of virtual disks.

Execution of a sequence of instructions to practice certain of the disclosed embodiments is performed by one or more instances of a software instruction processor, or a processing element such as a data processor, or such as a central processing unit (e.g., CPU1, CPU2, . . . , CPUN). According to certain embodiments of the disclosure, two or more instances of configuration 151 can be coupled by communications link 115 (e.g., backplane, LAN, PSTN, wired or wireless network, etc.) and each instance can perform respective portions of sequences of instructions as can be required to practice embodiments of the disclosure.

The shown computing platform 106 is interconnected to the Internet 148 through one or more network interface ports (e.g., network interface port 1231 and network interface port 1232). Configuration 151 can be addressed through one or more network interface ports using an IP address. Any operational element within computing platform 106 can perform sending and receiving operations using any of a range of network protocols, possibly including network protocols that send and receive packets (e.g., network protocol packet 1211 and network protocol packet 1212).

Computing platform 106 can transmit and receive messages that can be composed of configuration data and/or any other forms of data and/or instructions organized into a data structure (e.g., communications packets). In some cases, the data structure includes program instructions (e.g., application code) communicated through the Internet 148 and/or through any one or more instances of communications link 115. Received program instructions can be processed and/or executed by a CPU as it is received and/or program instructions can be stored in any volatile or non-volatile storage for later execution. Program instructions can be transmitted via an upload (e.g., an upload from an access device over the Internet 148 to computing platform 106). Further, program instructions and/or the results of executing program instructions can be delivered to a particular user via a download (e.g., a download from computing platform 106 over the Internet 148 to an access device).

Configuration 151 is merely one example configuration. Other configurations or partitions can include further data processors, and/or multiple communications interfaces, and/or multiple storage devices, etc. within a partition. For example, a partition can bound a multi-core processor (e.g., possibly including embedded or collocated memory), or a partition can bound a computing cluster having a plurality of computing elements, any of which computing elements are connected directly or indirectly to a communications link. A first partition can be configured to communicate to a second partition. A particular first partition and a particular second partition can be congruent (e.g., in a processing element array) or can be different (e.g., comprising disjoint sets of components).

A cluster is often embodied as a collection of computing nodes that can communicate between each other through a local area network (e.g., LAN or virtual LAN (VLAN)) or a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provisioning of power to other units. In some cases, a unit in a rack is dedicated to environmental conditioning functions such as filtering and movement of air through the rack and/or temperature control for the rack. Racks can be combined to form larger clusters. For example, the LAN of a first rack having a quantity of 32 computing nodes can be interfaced with the LAN of a second rack having 16 nodes to form a two-rack cluster of 48 nodes. The former two LANs can be configured as subnets, or can be configured as one VLAN. Multiple clusters can communicate between one module to another over a WAN (e.g., when geographically distal) or a LAN (e.g., when geographically proximal).

In some embodiments, a module can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to facilitate operational and/or performance characteristics pertaining to management of block stores. Various implementations of the data repository comprise storage media organized to hold a series of records and/or data structures.

Further details regarding general approaches to managing data repositories are described in U.S. Pat. No. 8,601,473 titled “ARCHITECTURE FOR MANAGING I/O AND STORAGE FOR A VIRTUALIZATION ENVIRONMENT,” issued on Dec. 3, 2013, which is hereby incorporated by reference in its entirety.

Further details regarding general approaches to managing and maintaining data in data repositories are described in U.S. Pat. No. 8,549,518 titled “METHOD AND SYSTEM FOR IMPLEMENTING A MAINTENANCE SERVICE FOR MANAGING I/O AND STORAGE FOR A VIRTUALIZATION ENVIRONMENT,” issued on Oct. 1, 2013, which is hereby incorporated by reference in its entirety.

FIG. 1B depicts a block diagram illustrating another virtualization system architecture 1B00 configured to implement one or more aspects of the present embodiments. As shown in FIG. 1B, virtualization system architecture 1B00 includes a collection of interconnected components, including an executable container instance 150 in a configuration 152. Configuration 152 includes a computing platform 106 that supports an operating system layer (as shown) that performs addressing functions such as providing access to external requestors (e.g., user virtual machines or other processes) via an IP address (e.g., “P.Q.R.S”, as shown). Providing access to external requestors can include implementing all or portions of a protocol specification (e.g., “http:”) and possibly handling port-specific functions. In some embodiments, external requestors (e.g., user virtual machines or other processes) rely on the aforementioned addressing functions to access a virtualized controller for performing all data storage functions. Furthermore, when data input or output requests are received from a requestor running on a first node are received at the virtualized controller on that first node, then in the event that the requested data is located on a second node, the virtualized controller on the first node accesses the requested data by forwarding the request to the virtualized controller running at the second node. In some cases, a particular input or output request might be forwarded again (e.g., an additional or Nth time) to further nodes. As such, when responding to an input or output request, a first virtualized controller on the first node might communicate with a second virtualized controller on the second node, which second node has access to particular storage devices on the second node or, the virtualized controller on the first node can communicate directly with storage devices on the second node.

The operating system layer can perform port forwarding to any executable container (e.g., executable container instance 150). An executable container instance can be executed by a processor. Runnable portions of an executable container instance sometimes derive from an executable container image, which in turn might include all, or portions of any of, a Java archive repository (JAR) and/or its contents, and/or a script or scripts and/or a directory of scripts, and/or a virtual machine configuration, and can include any dependencies therefrom. In some cases, a configuration within an executable container might include an image comprising a minimum set of runnable code. Contents of larger libraries and/or code or data that would not be accessed during runtime of the executable container instance can be omitted from the larger library to form a smaller library composed of only the code or data that would be accessed during runtime of the executable container instance. In some cases, start-up time for an executable container instance can be much faster than start-up time for a virtual machine instance, at least inasmuch as the executable container image might be much smaller than a respective virtual machine instance. Furthermore, start-up time for an executable container instance can be much faster than start-up time for a virtual machine instance, at least inasmuch as the executable container image might have many fewer code and/or data initialization steps to perform than a respective virtual machine instance.

An executable container instance can serve as an instance of an application container or as a controller executable container. Any executable container of any sort can be rooted in a directory system and can be configured to be accessed by file system commands (e.g., “Is” or “Is-a”, etc.). The executable container might optionally include operating system components 178, however such a separate set of operating system components need not be provided. As an alternative, an executable container can include runnable instance 158, which is built (e.g., through compilation and linking, or just-in-time compilation, etc.) to include all of the library and OS-like functions needed for execution of the runnable instance. In some cases, a runnable instance can be built with a virtual disk configuration manager, any of a variety of data IO management functions, etc. In some cases, a runnable instance includes code for, and access to, container virtual disk controller 176. Such a container virtual disk controller can perform any of the functions that the aforementioned CVM virtual disk controller 126 can perform, yet such a container virtual disk controller does not rely on a hypervisor or any particular operating system so as to perform its range of functions.

In some environments, multiple executable containers can be collocated and/or can share one or more contexts. For example, multiple executable containers that share access to a virtual disk can be assembled into a pod (e.g., a Kubernetes pod). Pods provide sharing mechanisms (e.g., when multiple executable containers are amalgamated into the scope of a pod) as well as isolation mechanisms (e.g., such that the namespace scope of one pod does not share the namespace scope of another pod).

FIG. 1C is a block diagram illustrating virtualization system architecture 1C00 configured to implement one or more aspects of the present embodiments. As shown in FIG. 1C, virtualization system architecture 1C00 includes a collection of interconnected components, including a user executable container instance in configuration 153 that is further described as pertaining to user executable container instance 170. Configuration 153 includes a daemon layer (as shown) that performs certain functions of an operating system.

User executable container instance 170 comprises any number of user containerized functions (e.g., user containerized function1, user containerized function2, . . . , user containerized functionN). Such user containerized functions can execute autonomously or can be interfaced with or wrapped in a runnable object to create a runnable instance (e.g., runnable instance 158). In some cases, the shown operating system components 178 comprise portions of an operating system, which portions are interfaced with or included in the runnable instance and/or any user containerized functions. In some embodiments of a daemon-assisted containerized architecture, computing platform 106 might or might not host operating system components other than operating system components 178. More specifically, the shown daemon might or might not host operating system components other than operating system components 178 of user executable container instance 170.

In some embodiments, the virtualization system architecture 1A00, 1B00, and/or 1C00 can be used in any combination to implement a distributed platform that contains multiple servers and/or nodes that manage multiple tiers of storage where the tiers of storage might be formed using the shown data repository 131 and/or any forms of network accessible storage. As such, the multiple tiers of storage can include storage that is accessible over communications link 115. Such network accessible storage can include cloud storage or networked storage (e.g., a SAN or storage area network). Unlike prior approaches, the disclosed embodiments permit local storage that is within or directly attached to the server or node to be managed as part of a storage pool. Such local storage can include any combinations of the aforementioned SSDs and/or HDDs and/or RAPMs and/or hybrid disk drives. The address spaces of a plurality of storage devices, including both local storage (e.g., using node-internal storage devices) and any forms of network-accessible storage, are collected to form a storage pool having a contiguous address space.

Significant performance advantages can be gained by allowing the virtualization system to access and utilize local (e.g., node-internal) storage. This is because I/O performance is typically much faster when performing access to local storage as compared to performing access to networked storage or cloud storage. This faster performance for locally attached storage can be increased even further by using certain types of optimized local storage devices such as SSDs or RAPMs, or hybrid HDDs, or other types of high-performance storage devices.

In some embodiments, each storage controller exports one or more block devices or NFS or iSCSI targets that appear as disks to user virtual machines or user executable containers. These disks are virtual since they are implemented by the software running inside the storage controllers. Thus, to the user virtual machines or user executable containers, the storage controllers appear to be exporting a clustered storage appliance that contains some disks. User data (including operating system components) in the user virtual machines resides on these virtual disks.

In some embodiments, any one or more of the aforementioned virtual disks can be structured from any one or more of the storage devices in the storage pool. In some embodiments, a virtual disk is a storage abstraction that is exposed by a controller virtual machine or container to be used by another virtual machine or container. In some embodiments, the virtual disk is exposed by operation of a storage protocol such as iSCSI or NFS or SMB. In some embodiments, a virtual disk is mountable. In some embodiments, a virtual disk is mounted as a virtual storage device.

In some embodiments, some or all of the servers or nodes run virtualization software. Such virtualization software might include a hypervisor (e.g., as shown in configuration 151) to manage the interactions between the underlying hardware and user virtual machines or containers that run client software.

Distinct from user virtual machines or user executable containers, a special controller virtual machine (e.g., as depicted by controller virtual machine instance 130) or as a special controller executable container is used to manage certain storage and I/O activities. Such a special controller virtual machine is sometimes referred to as a controller executable container, a service virtual machine (SVM), a service executable container, or a storage controller. In some embodiments, multiple storage controllers are hosted by multiple nodes. Such storage controllers coordinate within a computing system to form a computing cluster.

The storage controllers are not formed as part of specific implementations of hypervisors. Instead, the storage controllers run above hypervisors on the various nodes and work together to form a distributed system that manages all of the storage resources, including the locally attached storage, the networked storage, and the cloud storage. In example embodiments, the storage controllers run as special virtual machines-above the hypervisors-thus, the approach of using such special virtual machines can be used and implemented within any virtual machine architecture. Furthermore, the storage controllers can be used in conjunction with any hypervisor from any virtualization vendor and/or implemented using any combinations or variations of the aforementioned executable containers in conjunction with any host operating system components.

FIG. 1D is a block diagram illustrating virtualization system architecture 1D00 configured to implement one or more aspects of the present embodiments. As shown in FIG. 1D, virtualization system architecture 1D00 includes a distributed virtualization system that includes multiple clusters (e.g., cluster 183₁, . . . , cluster 183_{N}) comprising multiple nodes that have multiple tiers of storage in a storage pool. Representative nodes (e.g., node 181₁₁, . . . , node 181_{1M}) and storage pool 190 associated with cluster 183₁ are shown. Each node can be associated with one server, multiple servers, or portions of a server. The nodes can be associated (e.g., logically and/or physically) with the clusters. As shown, the multiple tiers of storage include storage that is accessible through a network 196, such as a networked storage 186 (e.g., a storage area network or SAN, network attached storage or NAS, etc.). The multiple tiers of storage further include instances of local storage (e.g., local storage 191₁₁, . . . , local storage 191_{1M}). For example, the local storage can be within or directly attached to a server and/or appliance associated with the nodes. Such local storage can include solid state drives (SSD 193₁₁, . . . , SSD 193_{1M}), hard disk drives (HDD 194₁₁, . . . , HDD 194_{1M}), and/or other storage devices.

As shown, any of the nodes of the distributed virtualization system can implement one or more user virtualized entities (e.g., VE 188¹¹¹, . . . , VE 188^{11K}, . . . , VE 188^{1M1}, . . . , VE 188^{1MK}), such as virtual machines (VMs) and/or executable containers. The VMs can be characterized as software-based computing “machines” implemented in a container-based or hypervisor-assisted virtualization environment that emulates the underlying hardware resources (e.g., CPU, memory, etc.) of the nodes. For example, multiple VMs can operate on one physical machine (e.g., node host computer) running a single host operating system (e.g., host operating system 187¹¹, . . . , host operating system 187^{1M}), while the VMs run multiple applications on various respective guest operating systems. Such flexibility can be facilitated at least in part by a hypervisor (e.g., hypervisor 185¹¹, . . . , hypervisor 185^{1M}), which hypervisor is logically located between the various guest operating systems of the VMs and the host operating system of the physical infrastructure (e.g., node).

As an alternative, executable containers can be implemented at the nodes in an operating system-based virtualization environment or in a containerized virtualization environment. The executable containers are implemented at the nodes in an operating system virtualization environment or container virtualization environment. The executable containers can include groups of processes and/or resources (e.g., memory, CPU, disk, etc.) that are isolated from the node host computer and other containers. Such executable containers directly interface with the kernel of the host operating system (e.g., host operating system 187₁₁, . . . , host operating system 187_{1M}) without, in most cases, a hypervisor layer. This lightweight implementation can facilitate efficient distribution of certain software components, such as applications or services (e.g., micro-services). Any node of a distributed virtualization system can implement both a hypervisor-assisted virtualization environment and a container virtualization environment for various purposes. Also, any node of a distributed virtualization system can implement any one or more types of the foregoing virtualized controllers so as to facilitate access to storage pool 190 by the VMs and/or the executable containers.

Multiple instances of such virtualized controllers can coordinate within a cluster to form the distributed storage system 192 which can, among other operations, manage the storage pool 190. This architecture further facilitates efficient scaling in multiple dimensions (e.g., in a dimension of computing power, in a dimension of storage space, in a dimension of network bandwidth, etc.).

In some embodiments, a particularly configured instance of a virtual machine at a given node can be used as a virtualized controller in a hypervisor-assisted virtualization environment to manage storage and I/O (input/output or IO) activities of any number or form of virtualized entities. For example, the virtualized entities at node 181₁₁ can interface with a controller virtual machine (e.g., virtualized controller 18211) through hypervisor 185₁₁ to access data of storage pool 190. In such cases, the controller virtual machine is not formed as part of specific implementations of a given hypervisor. Instead, the controller virtual machine can run as a virtual machine above the hypervisor at the various node host computers. When the controller virtual machines run above the hypervisors, varying virtual machine architectures and/or hypervisors can operate with the distributed storage system 192. For example, a hypervisor at one node in the distributed storage system 192 might correspond to software from a first vendor, and a hypervisor at another node in the distributed storage system 192 might correspond to a second software vendor. As another virtualized controller implementation example, executable containers can be used to implement a virtualized controller (e.g., virtualized controller 182_{1M}) in an operating system virtualization environment at a given node. In this case, for example, the virtualized entities at node 181_{1M} can access the storage pool 190 by interfacing with a controller container (e.g., virtualized controller 182_{1M}) through hypervisor 185_{1M} and/or the kernel of host operating system 187_{1M}.

In some embodiments, one or more instances of an agent can be implemented in the distributed storage system 192 to facilitate the herein disclosed techniques. Specifically, agent 184₁₁ can be implemented in the virtualized controller 182₁₁, and agent 184_{1M} can be implemented in the virtualized controller 182_{1M}. Such instances of the virtualized controller can be implemented in any node in any cluster. Actions taken by one or more instances of the virtualized controller can apply to a node (or between nodes), and/or to a cluster (or between clusters), and/or between any resources or subsystems accessible by the virtualized controller or the agents.

### Exemplary Computing System

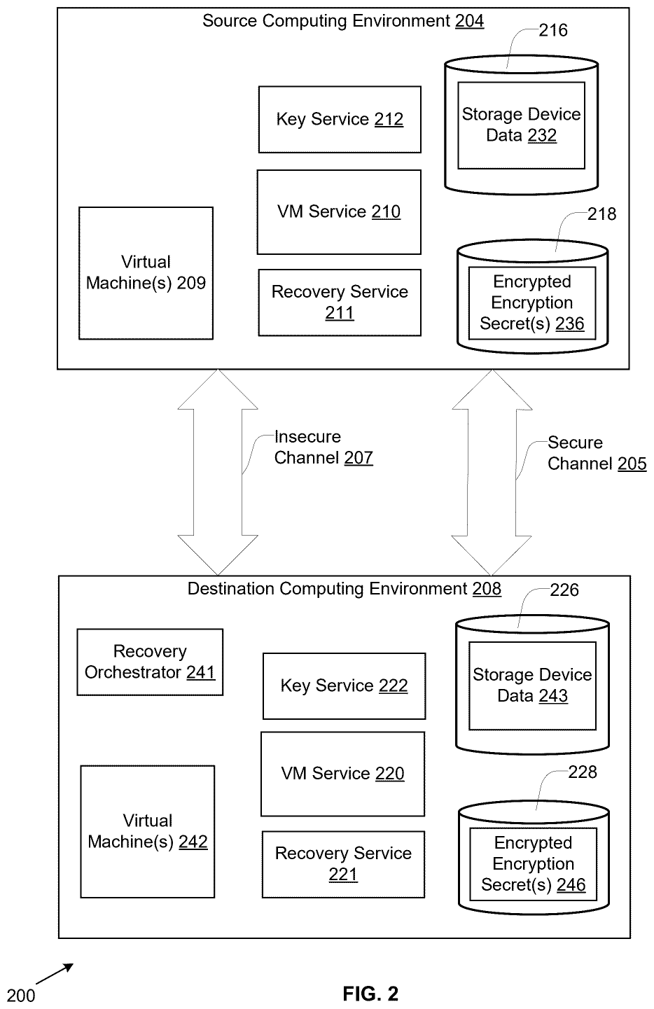

FIG. 2 is a block diagram illustrating a networked environment 200 in which one or more aspects of the present embodiments are implemented. As shown, networked environment 200 includes, without limitation, a source computing environment 204 and a destination computing environment 208 that are in communication over a secure channel 205 and an insecure channel 207. Source computing environment 204 includes, without limitation, one or more virtual machines 209, a VM service 210, a recovery service 211, key service 212, a storage device 216, and a database 218. Storage device 216 includes, without limitation, storage device data 232. Database 218 includes, without limitation, one or more encrypted encryption secrets 236. Destination computing environment 208 includes, without limitation, recovery orchestrator 241, one or more virtual machines 242, VM service 220, recovery service 221, key service 222, storage device 226, and database 228. In some embodiments, each of source computing environment 204 and destination computing environment 208 includes, without limitation, one or more processors, memory, a bus, and a communications interface. For example, source computing environment 204 and destination computing environment 208 shown in the networked environment 200 can correspond to a physical computing system (e.g., a system in a data center) or can include a virtual computing instance. In various embodiments, networked environment 200 and/or the elements of networked environment 200 can be included in any of the virtualization system architectures shown in FIGS. 1A-1D.

Secure channel 205 represents a secure communication network or mechanism for communicating data between source computing environment 204 and destination computing environment 208. Secure channel 205 includes, without limitation, an encrypted connection between source computing environment 204 and destination computing environment 208 such as TLS or SSL. Secure channel 205 also includes, without limitation, a remote procedure call framework that is implemented to facilitate secure communication between source computing environment 204 and destination computing environment 208 such as gRPC, or any other encrypted or secure communication channel between source computing environment 204 and destination computing environment 208. Secure channel 205 is implemented over a local or wide area network connection between source computing environment 204 and destination computing environment 208. In general, secure channel 205 is associated with higher processing and communication overhead relative to insecure channel 207.

Insecure channel 207 represents an insecure communication network for communicating data between source computing environment 204 and destination computing environment 208. Insecure channel 207 represents an unencrypted or insecure network connection between source computing environment 204 and destination computing environment 208. For example, insecure channel 207 can include a local or wide area network connection that is unencrypted or unsecured. In general, insecure channel 207 is associated with lower processing and communication overhead relative to secure channel 205.

When executed by source computing environment 204 and destination computing environment 208, VM service 210 and VM service 220 perform management of one or more virtual machines 209 or 242 that are executed within source computing environment 204. In one example, VM service 210 and VM service 220 store VM configurations corresponding to the one or more virtual machines 209 or 242 executed within source computing environment 204 or destination computing environment 208. A VM configuration includes metadata corresponding to a respective virtual machine 209 or virtual machine 242, such as processing resources, storage resources, network resources, or other hardware resources of the source computing environment 204 or destination computing environment 208 that are assigned to the virtual machine 209 or virtual machine 242. Additionally, in the case of a virtual machine 209 or virtual machine 242 that utilizes an encrypted virtual or physical storage device, VM service 210 or VM service 220 is responsible for maintaining an encryption secret that is used to encrypt an encrypted storage volume that is assigned to the virtual machine 209 or virtual machine 242. For example, the encryption secret can represent vTPM secret that is utilized by a vTPM module process executed by a hypervisor in the source computing environment 204 or destination computing environment 208 that encrypts a storage volume on behalf of the virtual machine 209 or virtual machine 242. The encrypted storage volume is referred to herein as an encrypted storage device. In this example, the encrypted storage device is stored in storage device 216 or storage device 226 as storage device data 232 or storage device data 243. The encryption secret is utilized by virtual machine 209 or virtual machine 242 to read from and write to the encrypted storage device via the hypervisor. A hypervisor running in source computing environment 204 or destination computing environment 208 executes a vTPM process that provides cryptographic functionalities to virtual machines 209 or virtual machines 242 that are generally provided by physical TPM processors. The hypervisor interacts with storage device 216 and storage device data 232 to decrypt data requested from an encrypted storage device by a virtual machine 209 or virtual machine 242 and to encrypt data written to the encrypted volume by the virtual machine 209 or virtual machine 242. While an example of a vTPM secret that is utilized for vTPM operations is disclosed, it should be appreciated that the VM service 210 or VM service 220 can manage any type of encryption secret on behalf of one or more virtual machines 209 or virtual machine 242 running in source computing environment 204 or destination computing environment 208.

The recovery service 211, when executed by source computing environment 204, performs operations to obtain an encryption secret managed by VM service 210 and utilized by one or more virtual machines 209 for the purpose of migration or failover to a destination computing environment 208. For example, the recovery service 211 obtains a VM configuration associated with a virtual machine 209 as well as an encryption secret associated with the virtual machine 209. The recovery service 211 also obtains storage device data 232 associated with an encrypted storage device associated with the virtual machine 209. The recovery service 211 then transmits the VM configuration, encryption secret, and the storage device data 232 associated with the virtual machine 209 to a destination computing environment 208. In one embodiment, the recovery service 211 requests a VM configuration and encryption secret corresponding to a particular virtual machine 209 from the VM service 210. The virtual machine 209 can include a virtual machine 209 that is being migrated to the destination computing environment 208 or a virtual machine 209 for which the recovery service 211 is configured to periodically obtain snapshot data for failover purposes.

Rather than providing the encryption secret to the recovery service 211 in decrypted form, for information security purposes, the VM service 210 provides an encrypted encryption secret. To encrypt the encryption secret, VM service 210 provides the encryption secret to the key service 212 and requests the key service 212 to encrypt the encryption secret. VM service 210 also provides a master key identifier with which the encryption secret should be encrypted by the key service 212. The master key corresponds to a key possessed by the key service 212 with which the encryption secret can be encrypted when the encryption secret is stored. The master key is specific to the source computing environment 204 such that the master key of the source computing environment 204 is different from a master key on the destination computing environment 208. The key service 212 comprises a key store or application that provides cryptographic operations, such as secure storage of encryption keys and encryption and decryption services to applications and virtual machines 209 running within source computing environment 204.

Accordingly, the recovery service 211 obtains an encrypted encryption secret 236 corresponding to an encrypted storage device of a virtual machine 209, a VM configuration corresponding to the virtual machine 209, and any other metadata associated with the virtual machine 209. The encrypted encryption secret is stored in database 218 by recovery service 211. The encrypted encryption secret 236 is stored in encrypted form so that the encryption secret is in decrypted form at rest. In some examples, the VM configuration and other metadata associated with a virtual machine 209 are also stored along with the encrypted encryption secret 236 in database 218.

As described above, the recovery service 211 obtains an encryption secret corresponding to a virtual machine 209 and saves the encryption secret to database 218 as an encrypted encryption secret 236. The recovery service 211 is also tasked with migrating a virtual machine 209 along with storage device data 232 corresponding an encrypted storage device of the virtual machine 209 from the source computing environment 204 to a destination computing environment 208. The recovery service 211 migrates a virtual machine 209 for failover purposes, load balancing purposes, at the request of an administrator, or for any other purposes as can be appreciated. Accordingly, to migrate a virtual machine 209, the encryption secret corresponding to an encrypted storage device must also be migrated to destination computing environment 208. Therefore, recovery service 211 retrieves an encrypted encryption secret 236 from database 218 and requests the key service 212 to decrypt the encrypted encryption secret 236. Key service 212 decrypts the encrypted encryption secret 236 and returns a decrypted form of the encryption secret to recovery service 211. Next, recovery service 211 transmits the decrypted encryption secret to recovery service 221 running in the destination computing environment 208 using the secure channel 205. Because secure channel 205 is a secure or encrypted communication link between source computing environment 204 and destination computing environment 208, the encryption secret is transmitted using the secure channel 205 in decrypted form.

Recovery service 221 executing in destination computing environment 208 receives the decrypted encryption secret via secure channel 205. The decrypted encryption secret corresponds to a virtual machine 209 being migrated or configured for failover to the destination computing environment 208. In some implementations, recovery service 221 also receives a VM configuration corresponding to the virtual machine 209 as well as other metadata associated with the virtual machine 209 used to deploy a virtual machine 242 in the destination computing environment 208.

Recovery service 221 requests a master encryption key identifier from the VM service 220. As noted above, the master encryption key used to encrypt the encryption secret before the encrypted secret is stored that is used by the destination computing environment 208 is different from the master encryption key used for the same purpose on the source computing environment 204. Upon receiving the master encryption key identifier from VM service 220, recovery service 221 requests key service 222 to encrypt the encryption secret received via the secure channel 205. The key service 222 encrypts the encryption secret using a master encryption key corresponding to the master encryption key identifier received from the VM service 220 and returns the encrypted encryption secret to the recovery service 221. The recovery service 221 then stores the encrypted encryption secret in database 228 as an encrypted encryption secret 246. In this way, the encryption secret is transmitted from the source computing environment 204 to the destination computing environment 208 in a secure manner and stored in a secure manner using an encryption key to which the destination computing environment 208 has access via the key service 222 running on destination computing environment 208. In some examples, recovery service 221 also stores a VM configuration and other metadata associated with the virtual machine 209 in the source computing environment 204 to the database 228.

In addition to receiving the encrypted encryption secret 236 via the secure channel 205, the recovery service 221 also receives storage device data 232 from recovery service 211 corresponding to an encrypted storage device of the virtual machine 209 via insecure channel 207. In the case of an encrypted storage device that is encrypted using an encrypted secret, the storage device data 232 is transmitted over the insecure channel 207 to recovery service 221 to reduce the processing and network overhead associated with using the secure channel 205. Because the storage device data 232 is already encrypted in this scenario, using the secure channel 205 would be an unnecessary use of the secure channel 205. Accordingly, in this way, the storage device data 232 corresponding to a virtual machine 209 is transmitted to destination computing environment 208 without consuming unnecessary processing and network resources associated with the secure channel 205. The recovery service 221 stores the storage device data 232 received from recovery service 211 as storage device data 243 in storage device 226. Once the encrypted encryption secret 236 and storage device data 232 are received in the destination computing environment 208 as described above, the data associated with virtual machine 209 is considered replicated to destination computing environment 208.

Recovery service 221, when executed by destination computing environment 208, performs recovery of virtual machines 242 in the destination computing environment 208. Recovery service 221 also replicates virtual machines 242 and encrypted storage devices in destination computing environment 208 to other computing environments in the same manner as recovery service 211 running in source computing environment 204.

The recovery orchestrator 241, when executed by destination computing environment 208, initiates recovery of a virtual machine 209 using the encrypted encryption secret 246 and storage device data 243. Recovery orchestrator 241 requests the encrypted encryption secret 246 from database 228. Recovery orchestrator 241 then requests key service 222 to decrypt the encrypted encryption secret 246. In one example, the key service 222 determines an encryption context from the encrypted encryption secret 246 to identify the master encryption key that was used to encrypt the encrypted encryption secret 246. Key service 222 decrypts the encrypted encryption secret 246 with the identified master encryption key accessible to the key service 222 and returns the decrypted encryption secret to recovery orchestrator 241. Recovery orchestrator 241 then requests VM service 220 to generate a virtual machine 242 using the decrypted encryption secret, storage device data 243 corresponding to the virtual machine 209 received from recovery service 211 in the destination computing environment 208, and any other VM configuration or metadata associated with the virtual machine 209 that was replicated from source computing environment 204 to destination computing environment 208. In one example, recovery orchestrator 241 requests VM service 220 to create the virtual machine 242 via an API or remote procedure call in which the decrypted encryption secret and a reference to storage device data 243 are provided as inputs. VM service 220, in some embodiments, encrypts the provided decrypted encryption secret with a different encryption key, which is referred to herein as a service level encryption key. The encryption key encrypted using the service level encryption key can be maintained by the VM service 220 in memory or stored in storage private to the VM service 220 for subsequent use by VM service 220.

In an alternative scenario for replicating an encryption secret and encrypted storage device from source computing environment 204 to destination computing environment 208, VM service 210 replicates a virtual machine 209 from source computing environment 204 to destination computing environment 208 using the insecure channel 207. In this scenario, VM service 210 running on source computing environment 204 requests key service 212 to decrypt an encrypted encryption secret maintained by VM service 210 that is encrypted using a service level encryption key. Key service 212 returns the decrypted encryption key to VM service 210. Next, VM service 210 requests key service 212 to encrypt the encryption secret with a master encryption key that is also shared from key service 212 to key service 222. Key service 212 returns to VM service 210 an encrypted encryption secret that is encrypted using a master encryption key. VM service 210 then transmits the encrypted encryption secret that is encrypted using the master encryption key to VM service 220 running on destination computing environment 208. In some examples, VM service 210 also transmits a VM configuration along with other metadata associated with a virtual machine 209 being replicated from source computing environment 204 to destination computing environment 208. Storage device data 232 corresponding to an encrypted storage device associated with the virtual machine 209 is also transmitted to VM service 210 using insecure channel 207. Because both the encryption secret and storage device data 232 corresponding to the encrypted storage device are encrypted, the insecure channel 207 can be used. Key service 212 transmits the master encryption key to key service 222 using the secure channel 205 so that the master encryption key used to encrypt the encryption secret corresponding to the encrypted storage volume is securely shared from source computing environment 204 to destination computing environment 208.

In destination computing environment 208, the VM service 220 receives the encrypted encryption secret encrypted using the master encryption key. VM service 220 requests key service 222 to decrypt the encrypted encryption secret. The key service 222 utilizes the master encryption key requested by the key service 222 from key service 212 to decrypt the encrypted encryption secret. The VM service 220 then requests the key service 222 to encrypt the encryption secret with a master encryption key associated with the destination computing environment 208 that is different from the master encryption key utilized by key service 212 in source computing environment 204. Key service 222 returns the encrypted encryption secret that is encrypted using the master encryption key of the destination computing environment 208. The encrypted encryption secret is stored to database 228 so that VM service 220 can later access and utilize the encryption secret to create a virtual machine 242 in the destination computing environment 208 and access an encrypted storage device for which storage device data 232 is received from the source computing environment 204.

Storage device 216 and/or storage device 226 includes non-volatile storage for applications and data. Storage device 216 and/or storage device 226 can include, without limitation, one or more fixed or removable disk drives, HDDs, SSD, NVMes, vDisks, flash memory devices, and/or other magnetic, optical, and/or solid-state storage devices. As noted above, a hypervisor running on source computing environment 204 and/or destination computing environment 208 executes a vTPM process that allows virtual machine 209 and/or virtual machine 242 to store and access encrypted volumes on storage device 216 and/or storage device 226 that are encrypted using an encryption secret.

When executed by source computing environment 204 or destination computing environment 208, key service 212 and key service 222 represent a local key store that provides cryptographic operations and credential management of encryption keys, certificates, or other credentials. Key service 212 and key service 222 encrypt and decrypt data items that are provided by other applications, services, or virtual machines running in source computing environment 204 and destination computing environment 208, respectively.

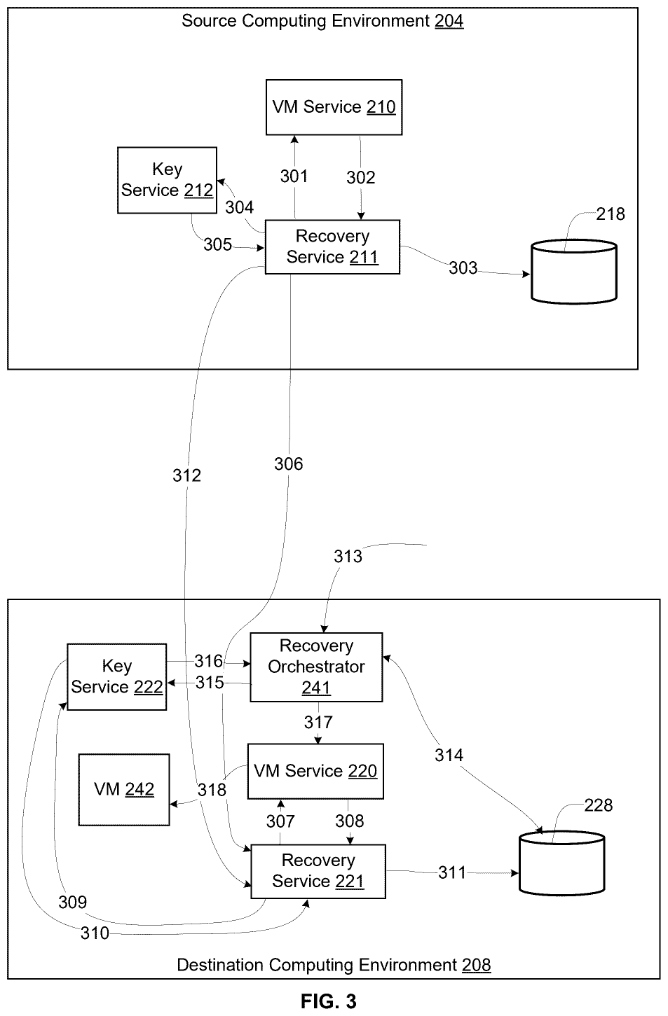

FIG. 3 is a block diagram illustrating how a source computing environment and destination computing environment replicate and recover an encrypted storage device and encryption secret, according to one or more aspects of the present embodiments. FIG. 3 illustrates one example of a series of ordered steps for replicating and recovering an encrypted storage device and encryption secret from a source computing environment 204 to a destination computing environment 208. It should be appreciated that the depicted steps can be performed in a different ordering.

First at step 301, recovery service 211 requests an encryption secret corresponding to an encrypted storage device. The encrypted storage device is associated with a virtual machine 209 in the source computing environment 204. At step 302, VM service 210 returns an encrypted encryption secret to recovery service 211. In one example, the encryption secret was previously encrypted by key service 212 for VM service 210 using a master encryption key that is local to source computing environment 204.

At step 303, recovery service 211 stores the encrypted encryption secret to database 218. In some examples, the encrypted encryption secret is stored to database 218 along with an encryption context that allows key service 212 to later identify a master encryption key used to encrypt the encrypted encryption secret. Steps 301, 302, and 303 are referred to as the snapshot phase of a disaster recovery framework in that the encryption secret needed by the recovery service 211 to facilitate recovery or failover of a virtual machine 209 in a destination computing environment 208 has been saved to the database 218.

At step 304, recovery service 211 enters a replication phase. In the replication phase, recovery service 211 facilitates communication of the encryption secret and storage device data 232 corresponding to an encrypted storage device of a virtual machine 209 to destination computing environment 208. At step 304, recovery service 211 requests a decrypted encryption secret corresponding to the encrypted storage volume by providing the encrypted encryption secret 236 from database 218 to the key service 212. Key service 212 identifies a master encryption key used to encrypt the encryption secret from the encryption context stored with the encrypted encryption secret 236 in database 218. At step 305, key service 212 returns a decrypted encryption secret to recovery service 211. At step 306, recovery service 211 transmits the decrypted encryption secret using secure channel 205 to recovery service 221 on destination computing environment 208.

Moving to destination computing environment 208, recovery service 221, upon receiving the decrypted encryption secret from recovery service 211 in source computing environment 204, requests a master encryption key identifier from VM service 220 at step 307. The master encryption key identifier corresponds to a master encryption key associated with destination computing environment 208 that is managed by key service 222 and that is utilized to later encrypt the encryption secret in destination computing environment 208. At step 308, VM service 220 returns the master encryption key identifier to recovery service 221. At step 309, recovery service 221 requests key service 222 to encrypt the decrypted encryption secret. The request includes the master encryption key identifier obtained from VM service 220 at step 308.

At step 310, recovery service 221 returns the encrypted encryption secret that is encrypted using the master encryption key associated with destination computing environment 208. At step 311, key service 212 stores the encrypted encryption secret in database 228 as encrypted encryption secret 246. At step 312, recovery service 221 receives the storage device data 232 corresponding to the encrypted storage device of the virtual machine 209 from recovery service 211. The storage device data 232 is sent using insecure channel 207 between source computing environment 204 and destination computing environment 208.

At step 313, recovery orchestrator 241 enters a recovery phase in which recovery orchestrator 241 recovers a virtual machine 209 and/or an encrypted storage device replicated from source computing environment 204 in destination computing environment 208. At step 313, recovery orchestrator 241 receives a request to recover a virtual machine 209 or encrypted storage volume in destination computing environment 208. The request can be triggered by failure of the virtual machine 209 in source computing environment 204 or by a user.

At step 314, recovery orchestrator 241 obtains encrypted encryption secret 246 from database 228. Encrypted encryption secret 246 includes an encryption context identifying a master encryption key with which the encrypted encryption secret 246 is encrypted. At step 315, recovery orchestrator 241 requests key service 222 to decrypt the encrypted encryption secret 246 obtained from database 228. At step 316, key service 222 returns the decrypted encryption secret.

At step 317, recovery orchestrator 241 requests the VM service 220 to create a virtual machine 242 using the encryption secret provided by the recovery orchestrator 241 as well as the storage device data 243 stored in database 228 of destination computing environment 208 by recovery service 221. The request to VM service 220 can also include a VM configuration and other metadata obtained from recovery service 211 in the source computing environment 204. Accordingly, at step 318, VM service 220 creates a virtual machine 242 using the encryption secret and encrypted storage device.

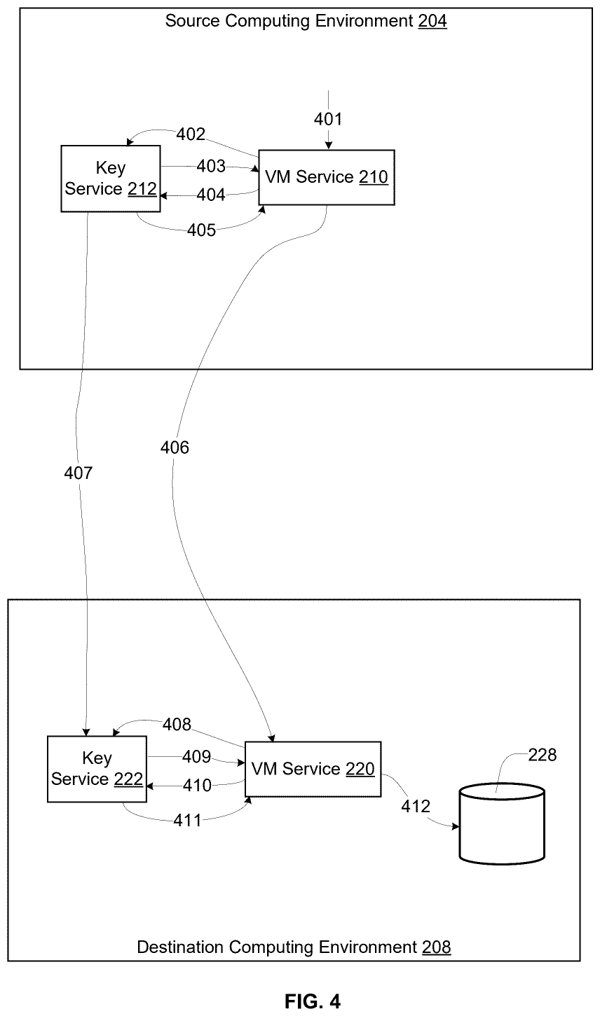

FIG. 4 is a block diagram illustrating how a source computing environment 204 and destination computing environment 208 replicate an encryption secret corresponding to an encrypted storage device, according to one or more aspects of the present embodiments. FIG. 4 illustrates one example of a series of ordered steps for replicating an encryption secret from a source computing environment 204 to a destination computing environment 208. It should be appreciated that the depicted steps can be performed using a different ordering.

First, at step 401, VM service 210 receives a request to replicate an encryption secret corresponding to an encrypted storage device corresponding to a virtual machine 209. The encrypted storage device is stored in storage device 216 as storage device data 232. The encryption secret is stored by VM service 210 as an encrypted encryption secret that is encrypted using a service level encryption key that is local to source computing environment 204 and not shared with destination computing environment 208.

Next, at step 402, VM service 210 requests key service 212 to decrypt the encryption secret that is encrypted with the service level encryption key. At step 403, key service 212 decrypts the encryption secret and returns the decrypted encryption secret to VM service 210. At step 404, VM service 210 requests key service 212 to encrypt the decrypted encryption secret with a master encryption key. The master encryption key is an encryption key that is shared from key service 212 on source computing environment 204 to key service 222 on destination computing environment 208, while the service level encryption key is not shared between source computing environment 204 and destination computing environment 208. At step 405, key service 212 returns the encryption secret that has been encrypted with the master encryption key.

At step 406, VM service 210 transmits the encrypted encryption secret to VM service 220 in destination computing environment 208. The VM service 210 transmits the encrypted encryption secret using insecure channel 207 because the encryption secret has been encrypted by VM service 220. By using insecure channel 207 rather than secure channel 205, processing and networking resources associated with using secure channel 205 are spared. At step 407, key service 212 transmits the master encryption key used to encrypt the encryption secret sent to VM service 220 at step 406 to key service 222 in destination computing environment 208. In step 407, key service 212 transmits the master encryption key using secure channel 205 so that the master encryption key is securely transmitted to destination computing environment 208.

At step 408, VM service 220 requests key service 222 to decrypt the encrypted encryption secret received from VM service 210 at step 406. At step 409, key service 222 returns the decrypted encryption secret to VM service 220. Key service 222 identifies the master encryption key needed to decrypt the encryption secret based upon an encryption context associated with the encrypted encryption secret provided by the VM service 220 at step 408.

Next, at step 410, VM service 220 requests VM service 220 to encrypt the encryption secret with a master encryption key that is local to destination computing environment 208. At step 411, key service 222 encrypts the encryption secret with the master encryption key of the destination computing environment 208. At step 412, VM service 220 stores the encrypted encryption secret in database 228 as encrypted encryption secret 236. In some examples, a VM configuration associated with a virtual machine 209 is stored along with encrypted encryption secret 236 in database 228. In the event of an unplanned failover to virtual machine 209, VM service 220 retrieves the encrypted encryption secret 236 and VM configuration from database 228 to restore a virtual machine 209 that has failed over to destination computing environment 208.

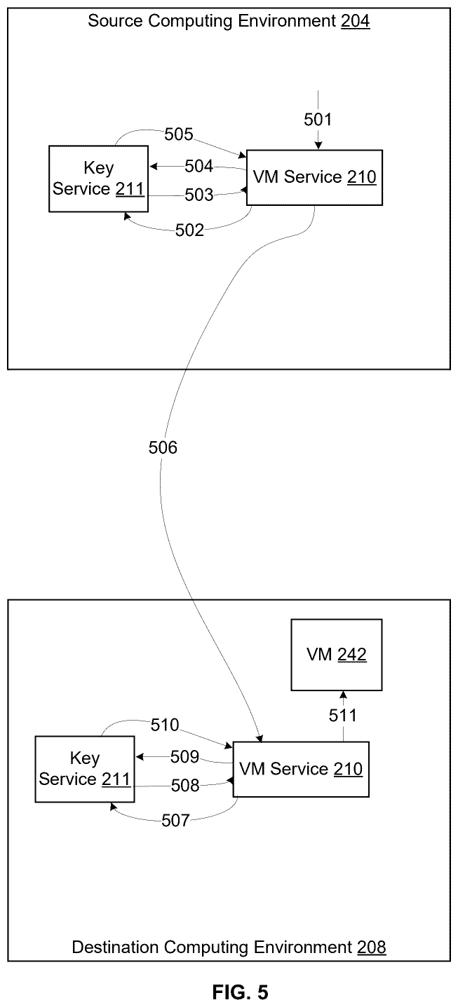

FIG. 5 is a block diagram illustrating how a source computing environment 204 and destination computing environment 208 replicate an encryption secret corresponding to an encrypted storage device as well as the data on the encrypted storage device, according to one or more aspects of the present embodiments. FIG. 5 illustrates one example of a series of ordered steps for replicating an encryption secret and encrypted storage device from a source computing environment 204 to a destination computing environment 208. It should be appreciated that the depicted steps can be performed using a different ordering.

First, at step 501, VM service 210 receives a request to replicate an encryption secret and data corresponding to an encrypted storage device for a virtual machine 209. The data corresponding to the encrypted storage device is stored in storage device 216 as storage device data 232. The encryption secret is stored by VM service 210 as an encrypted encryption secret that is encrypted using a service level encryption key that is local to source computing environment 204.

Next, at step 502, VM service 210 requests key service 212 to decrypt the encryption secret that is encrypted with the service level encryption key. At step 503, key service 212 decrypts the encryption secret and returns the decrypted encryption secret to VM service 210. At step 504, VM service 210 requests key service 212 to encrypt the decrypted encryption secret with a master encryption key. At step 505, key service 212 returns the encryption secret that has been encrypted with the master encryption key.

At step 506, VM service 210 transmits the encrypted encryption secret to VM service 220 in destination computing environment 208. The VM service 210 transmits the encrypted encryption secret using insecure channel 207 because the encryption secret has been encrypted by VM service 220. VM service 210 also transmits the data for the encrypted storage device using insecure channel 207. By using insecure channel 207 rather than secure channel 205, processing and networking resources associated with using secure channel 205 are spared.

At step 507, VM service 220 requests key service 222 to decrypt the encrypted encryption secret previously received from VM service 210 at step 407 of FIG. 4. At step 508, key service 222 returns the decrypted encryption secret to VM service 220. Key service 222 identifies the master encryption needed to decrypt the encryption secret based upon an encryption context associated with the encrypted encryption key provided by the VM service 220 at step 507. Next, at step 509, VM service 220 requests VM service 220 to encrypt the encryption secret with a service level key that is local to destination computing environment 208 and not shared with source computing environment 204.

At step 510, key service 222 encrypts the encryption secret with the service level key and returns the encrypted encryption secret to VM service 210. At step 511, VM service 210 creates a virtual machine 242 based on the data corresponding to the encrypted storage device and encryption secret received at step 507. The virtual machine 242 utilizes the encryption secret to access the encrypted storage device, which is stored in storage device 226 as storage device data 243.

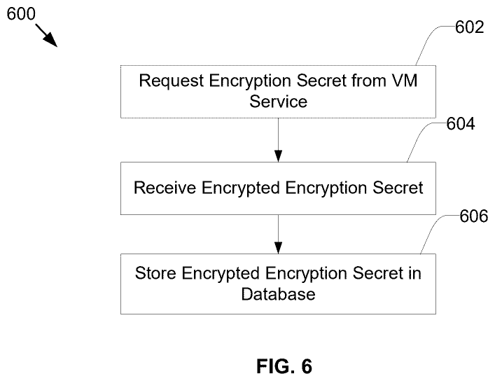

FIG. 6 is a flow diagram illustrating an example method for storing an encrypted encryption secret in a database, according to one or more aspects of the present embodiments. Although the method steps are described in conjunction with FIGS. 1A-3, persons skilled in the art will understand that any system configured to perform the method steps, in any order, falls within the scope of the present invention. The method 600 of FIG. 6 can be implemented by recovery service 211 in a source computing environment 204. In the discussion of FIG. 6, a non-limiting illustrative discussion is presented with respect to recovery service 211 performing the steps of the method.

First, at step 602, recovery service 211 requests an encryption secret corresponding to a virtual machine 209 in source computing environment 204 from VM service 210. The encryption secret can include a vTPM secret that is used to encrypt data on an encrypted storage device corresponding to the virtual machine 209.

At step 604, recovery service 211 receives an encrypted encryption secret from VM service 210. The encryption secret is encrypted using a master encryption key that is local to source computing environment 204 and not shared with destination computing environment 208. At step 606, recovery service 211 saves the encrypted encryption secret to database 218 as encrypted encryption secret 236.

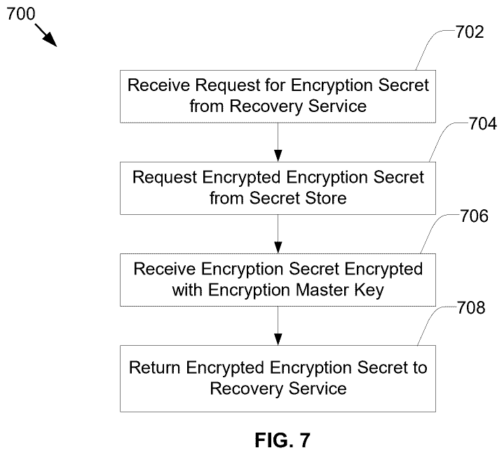

FIG. 7 is a flow diagram illustrating an example method for providing an encrypted encryption secret to a recovery service 211, according to one or more aspects of the present embodiments. Although the method steps are described in conjunction with FIGS. 1A-3, persons skilled in the art will understand that any system configured to perform the method steps, in any order, falls within the scope of the present invention. The method 700 of FIG. 7 can be implemented by VM service 210 in a source computing environment 204. In the discussion of FIG. 7, a non-limiting illustrative discussion is presented with respect to VM service 210 performing the steps of the method.

First, at step 702, VM service 210 receives a request for an encryption secret corresponding to an encrypted storage device for a virtual machine 209. The encryption secret can include a vTPM secret that is used to encrypt data on an encrypted storage device utilized by the virtual machine 209.

At step 704, VM service 210 requests key service 212 to encrypt the encryption secret with a master encryption key corresponding to source computing environment 204. VM service 210 internally stores the encryption secret that is encrypted with a service level key. For information security purposes, when providing the encryption secret to recovery service 211, VM service 210 provides the encryption secret that is encrypted using a different encryption key.

At step 706, VM service 210 receives the encryption secret that is encrypted using a master encryption key that is different from a service level key used to encrypt the encryption secret when the encryption secret is stored and used internally by the VM service 210. At step 708, VM service 210 returns the encrypted encryption secret to recovery service 211. Again, the encrypted encryption secret is encrypted using a master encryption key.

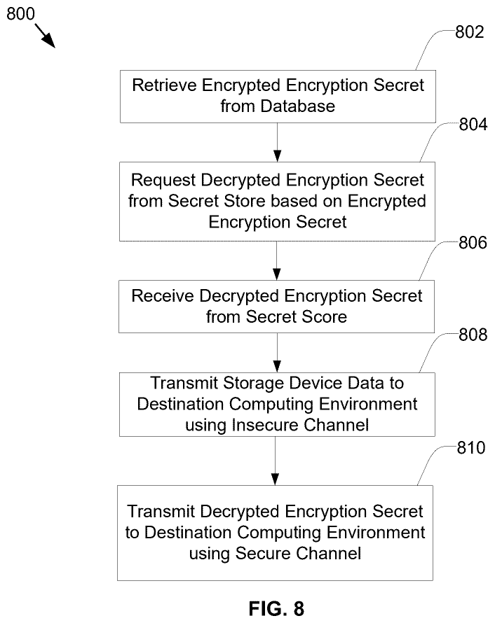

FIG. 8 is a flow diagram illustrating an example method for securely transmitting an encryption data and data from an encrypted storage device to a destination computing environment, according to one or more aspects of the present embodiments. Although the method steps are described in conjunction with FIGS. 1A-3, persons skilled in the art will understand that any system configured to perform the method steps, in any order, falls within the scope of the present invention. The method 800 of FIG. 8 can be implemented by recovery service 211 in a source computing environment 204. In the discussion of FIG. 8, a non-limiting illustrative discussion is presented with respect to recovery service 211 performing the steps of the method.

At step 802, recovery service 211 retrieves encrypted encryption secret 236 corresponding to a virtual machine 209 and encrypted storage device from database 228. In the example of FIG. 8, the encrypted encryption secret 236 is encrypted with a master encryption key that is local to source computing environment 204 and is not shared with destination computing environment 208.

At step 804, recovery service 211 requests key service 212 to decrypt encrypted encryption secret 236. The request includes a copy of or a reference to encrypted encryption secret 236 as well as an encryption context that identifies the master encryption key with which the encrypted encryption secret 236 is encrypted. At step 806, recovery service 211 receives the decrypted encryption secret from key service 212.

At step 808, recovery service 211 transmits the data corresponding to the encrypted storage device, or storage device data 232, to recovery service 221 running on destination computing environment 208 using insecure channel 207. Insecure channel 207 can be utilized to transmit data corresponding to the encrypted storage device because the data is already encrypted, so using the secure channel 205 would result in unnecessary processing and networking overhead. Additionally, the data corresponding to the encrypted storage device need not be decrypted by the recover service 211 and sent over the secure channel 205, received at recovery service 221, and re-encrypted by recovery service 221, which would result in significant processing overhead.

At step 810, recovery service 211 transmits the decrypted encryption secret obtained at step 806 to recovery service 221 using secure channel 205. Because the encryption secret is decrypted, a secure channel 205 is utilized to maintain the security of the encryption secret.

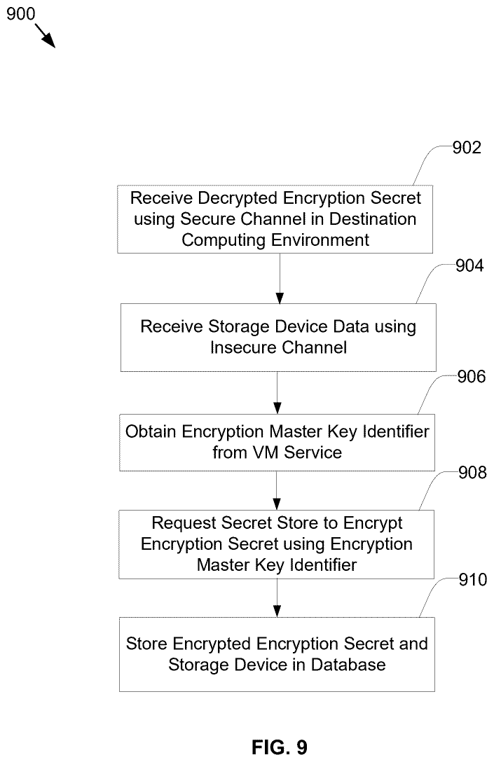

FIG. 9 is a flow diagram illustrating an example method for receiving data from an encrypted storage device at a destination computing environment, according to one or more aspects of the present embodiments. Although the method steps are described in conjunction with FIGS. 1A-3, persons skilled in the art will understand that any system configured to perform the method steps, in any order, falls within the scope of the present invention. The method 900 of FIG. 9 can be implemented by recovery service 221 in destination computing environment 208. In the discussion of FIG. 9, a non-limiting illustrative discussion is presented with respect to recovery service 221 performing the steps of the method.

At step 902, recovery service 221 receives a decrypted encryption secret in destination computing environment 208. The decrypted encryption secret corresponds to corresponding to an encrypted storage device of a virtual machine 209 from recovery service 211 in source computing environment 204. Recovery service 221 receives the decrypted encryption secret using secure channel 205.

At step 904, recovery service 221 receives storage device data 232 corresponding to an encrypted storage device via insecure channel 207. The insecure channel 207 can be utilized to receive storage device data 232 because the data is already encrypted using the encryption secret.

At step 906, recovery service 221 obtains a master encryption key identifier from VM service 220. The master encryption key identifier is associated with a master encryption key that is utilized to encrypt the encryption secret before the encryption secret is stored in database 228.

At step 908, recovery service 221 requests key service 222 to encrypt the decrypted encryption secret with the master encryption key. The recovery service 221 includes the master encryption key identifier obtained at step 906 in the request to key service 222. At step 910, recovery service 221 stores the encrypted encryption secret encrypted by key service 222 using master encryption key in database 228 as encrypted encryption secret 236.

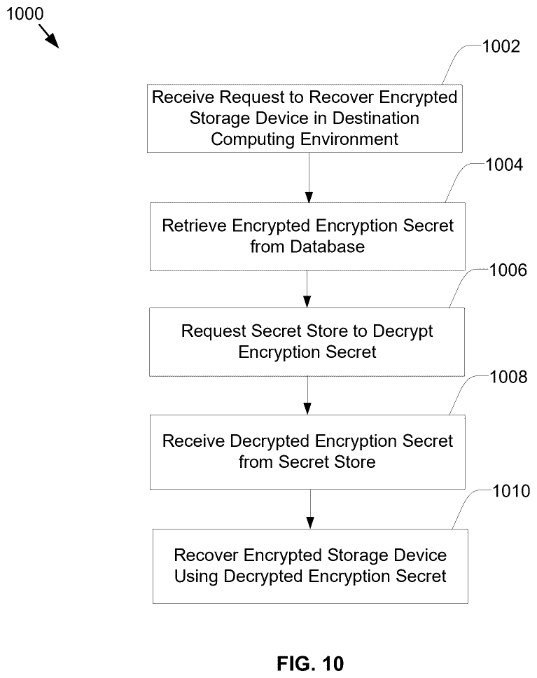

FIG. 10 is a flow diagram illustrating an example method for recovering an encrypted storage device in a destination computing environment, according to one or more aspects of the present embodiments. Although the method steps are described in conjunction with FIGS. 1A-3, persons skilled in the art will understand that any system configured to perform the method steps, in any order, falls within the scope of the present invention. The method 1000 of FIG. 10 can be implemented by recovery orchestrator 241 in destination computing environment 208. In the discussion of FIG. 10, a non-limiting illustrative discussion is presented with respect to recovery orchestrator 241 performing the steps of the method.

At step 1002, recovery orchestrator 241 receives a request to recover an encrypted storage device. The request can also include a request to recover a virtual machine 209 from source computing environment 204 in destination computing environment 208.

At step 1004, recovery orchestrator 241 retrieves encrypted encryption secret 246 corresponding to the encrypted storage device or the virtual machine 209 from database 228. The encrypted encryption secret 246 is encrypted using the master encryption key of the destination computing environment 208.

At step 1006, recovery orchestrator 241 requests key service 222 to decrypt encrypted encryption secret 246. The request includes an encryption context that identifies the master encryption key with which the encrypted encryption secret 246 was encrypted. At step 1008, recovery orchestrator 241 receives the decrypted encryption secret from key service 222.

At step 1010, recovery orchestrator 241 recovers the encrypted storage device based on the encryption secret and the storage device data 232 corresponding to the encrypted storage device. The data corresponding to the encrypted storage device is accessed from storage device data 243 in storage device 226. The storage device data 243 was previously obtained from source computing environment 204 by recovery service 221 as described above in the discussion of FIG. 9. Recovery orchestrator 241 recovers the encrypted storage device by requesting VM service 220 to create a virtual machine 242 that utilizes the encrypted storage device. The data corresponding to encrypted storage device is stored in storage device data 232.

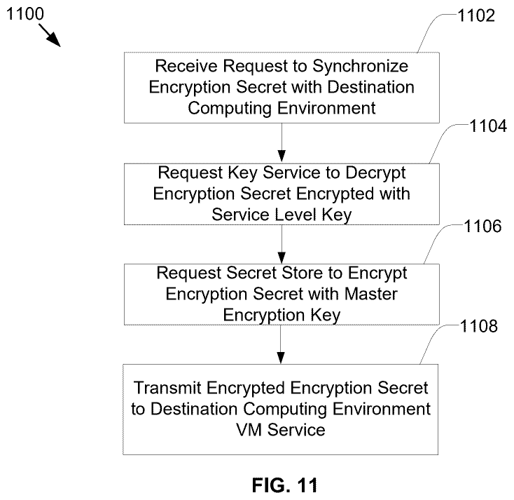

FIG. 11 is a flow diagram illustrating an example method for transmitting an encryption secret from a source computing environment 204 to a destination computing environment 208, according to one or more aspects of the present embodiments. Although the method steps are described in conjunction with FIGS. 1A and 4-5, persons skilled in the art will understand that any system configured to perform the method steps, in any order, falls within the scope of the present invention. The method 1100 of FIG. 11 can be implemented by VM service 210 in source computing environment 204. In the discussion of FIG. 11, a non-limiting illustrative discussion is presented with respect to VM service 210 performing the steps of the method.

At step 1102, VM service 210 receives a request to synchronize an encryption secret corresponding to an encrypted storage device with a destination computing environment 208. The request can be generated by a user configuring failover or migration of one or more virtual machines 209.

At step 1104, VM service 210 requests key service 212 to decrypt the encryption secret that is encrypted with a service level key that is not shared with destination computing environment 208. At step 1106, after receiving the decrypted encryption secret from key service 212, VM service 210 requests the key service 212 to encrypt the encryption secret using a master encryption key that is shared between source computing environment 204 and destination computing environment 208.

At step 1108, VM service 210 transmits the encrypted encryption secret to VM service 220 running on destination computing environment 208. VM service 210 utilizes insecure channel 207 because the encryption secret is encrypted, sparing unnecessary processor and networking overhead associated with using secure channel 205.

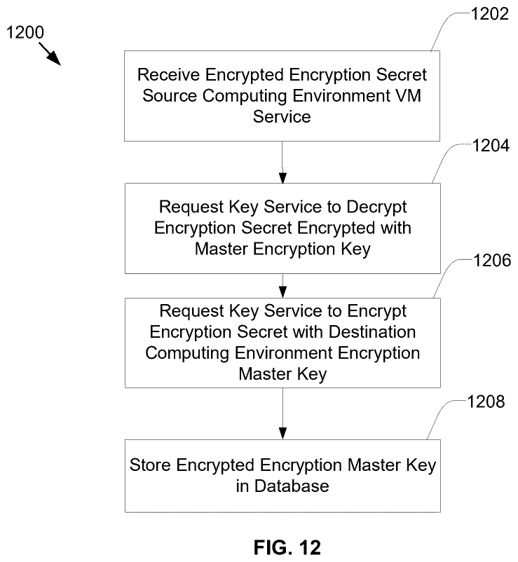

FIG. 12 is a flow diagram illustrating an example method for receiving an encryption secret from a source computing environment 204 at a destination computing environment 208, according to one or more aspects of the present embodiments. Although the method steps are described in conjunction with FIGS. 1A and 4-5, persons skilled in the art will understand that any system configured to perform the method steps, in any order, falls within the scope of the present invention. The method 1200 of FIG. 12 can be implemented by VM service 220 in destination computing environment 208. In the discussion of FIG. 12, a non-limiting illustrative discussion is presented with respect to VM service 220 performing the steps of the method.

At step 1202, VM service 220 in destination computing environment 208 receives the encrypted encryption secret from VM service 210 in source computing environment 204. The encrypted encryption secret is encrypted with the master encryption key and transmitted to VM service 220 using insecure channel 207. The master encryption key is shared from key service 212 to key service 222. At step 1204, VM service 220 requests key service 222 to decrypt the encrypted encryption secret using the master encryption key shared from key service 212 to key service 222.

At step 1206, after obtaining the decrypted encryption secret from key service 222, VM service 220 requests key service 222 to encrypt the encryption secret using a master encryption key corresponding to destination computing environment 208. Next, at step 1208, VM service 220 stores the encrypted encryption key encrypted using the master encryption key of destination computing environment 208 to the database 228.

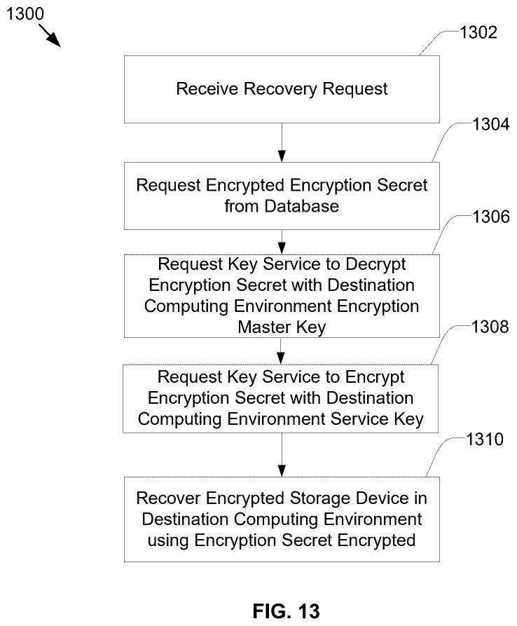

FIG. 13 is a flow diagram illustrating an example method for recovering an encrypted storage device in a destination computing environment 208, according to one or more aspects of the present embodiments. Although the method steps are described in conjunction with FIGS. 1A and 4-5, persons skilled in the art will understand that any system configured to perform the method steps, in any order, falls within the scope of the present invention. The method 1300 of FIG. 13 can be implemented by VM service 220 in destination computing environment 208. In the discussion of FIG. 13, a non-limiting illustrative discussion is presented with respect to VM service 220 performing the steps of the method.

At step 1302, VM service 220 receives a request to recover an encrypted storage device in destination computing environment 208. The request can accompany a request to migrate or failover a virtual machine from source computing environment 204 to destination computing environment 208.

At step 1304, VM service 220 requests encrypted encryption secret 236 from database 228. The encrypted encryption secret 236 was stored in database 228 as a part of the method for sharing the encryption secret in the discussion of FIG. 12.

At step 1306, upon receiving the encrypted encryption secret 236 from database 228, VM service 220 requests key service 222 to decrypt encrypted encryption secret 236. The encrypted encryption secret 236 is encrypted using the master encryption key of destination computing environment 208.

At step 1308, upon receiving the decrypted encryption secret from key service 222, VM service 220 requests key service 222 to encrypt the encryption secret with a service level key associated with the VM service 220 in the destination computing environment 208. The service level key is a key that is not shared between source computing environment 204, destination computing environment 208, or another computing environment.

At step 1310, VM service 220 recovers the encrypted storage device in the destination computing environment 208 using the encryption secret as well as storage device data 232 corresponding to the encrypted storage device that was obtained from source computing environment 204.

In sum, the disclosed techniques facilitate migration and disaster recovery of vTPM enabled virtual machines in which a vTPM secret used to encrypt disk volumes associated the virtual machines is securely provided by a source cluster to a destination cluster. The disclosed techniques include transmitting, by a primary site, an encryption secret for an encrypted storage device to a secondary site, where the encrypted storage device storing data encrypted based on the encryption secret. The disclosed techniques also include transmitting, by the primary site using an unsecure channel, the data as encrypted based on the encryption secret to the secondary site. In one example, the encryption secret is transmitted from the primary site to the secondary site using a secure channel and the data encrypted based on the encrypted secret is transmitted using an insecure channel. In another example, the encrypted secret is encrypted using an encryption key that is transmitted from the primary site to the secondary site using a secure channel, while the encryption secret and data encrypted based on the encrypted secret are transmitted to the secondary site using an insecure channel.

At least one technical advantage of the disclosed techniques relative to the prior art is that, with the disclosed techniques, VMs or disk volumes associated with VMs need not be decrypted and re-encrypted for secure migration or replication, which reduces processing resources to perform migration or disaster recovery. Additionally, a shared key store need not be required to allow for different environments to access the encrypted disk volume or VM.
1. In some embodiments, one or more non-transitory computer-readable media store program instructions that, when executed by one or more processors associated with a primary site, cause the one or more processors to perform a method comprising transmitting, by the primary site, an encryption secret for an encrypted storage device to a secondary site, the encrypted storage device storing data encrypted based on the encryption secret, and transmitting, by the primary site using an unsecure channel, the data as encrypted based on the encryption secret to the secondary site.
2. The one or more non-transitory computer-readable media of clause 1, wherein transmitting the encryption secret for the encrypted storage device to the secondary site is performed using a secure channel between the primary site and the secondary site.
3. The one or more non-transitory computer-readable media of clauses 1 or 2, further comprising transmitting, by the primary site using the secure channel, a virtual machine configuration associated with the data as encrypted.
4. The one or more non-transitory computer-readable media of any of clauses 1-3, wherein transmitting the encryption secret for the encrypted storage device to the secondary site further comprises encrypting the encryption secret using an encryption key associated with the primary site.
5. The one or more non-transitory computer-readable media of any of clauses 1-4, wherein the encryption key is different from the encryption secret.
6. The one or more non-transitory computer-readable media of any of
clauses 1-5, wherein the data as encrypted is not decrypted prior to being transmitted.
7. The one or more non-transitory computer-readable media of any of clauses 1-6, wherein the encryption secret is a virtual trusted platform (vTPM) secret.
8. The one or more non-transitory computer-readable media of any of clauses 1-7, wherein the encrypted storage device is a disk volume.
9. The one or more non-transitory computer-readable media of any of clauses 1-8, further comprising receiving, at the primary site, the encryption secret from a first local secure store of the primary site, wherein the encryption secret is transmitted to the secondary site for encryption by a second local secure store of the secondary site.
10. The one or more non-transitory computer-readable media of any of clauses 1-9, wherein the first local secure store is a key store.
11. The one or more non-transitory computer-readable media of any of clauses 1-10, further comprising receiving, by a recovery service at the primary site, the encryption secret in encrypted form from a virtual machine (VM) service at the primary site, and sending the encryption secret to the first local secure store for decryption.
12. In some embodiments, a method comprises transmitting, by a primary site, an encryption secret for an encrypted storage device to a secondary site, the encrypted storage device storing data encrypted based on the encryption secret, and transmitting, by the primary site using an unsecure channel, the data as encrypted based on the encryption secret to the secondary site.
13. The method of clause 12, wherein transmitting the encryption secret for the encrypted storage device to the secondary site is performed using a secure channel between the primary site and the secondary site.
14. The method of clauses 12 or 13, further comprising transmitting, by the primary site using the secure channel, a virtual machine configuration associated with the data as encrypted.
15. The method of any of clauses 12-14, wherein transmitting the encryption secret for the encrypted storage device to the secondary site further comprises encrypting the encryption secret using an encryption key associated with the primary site.
16. The method of any of clauses 12-15, wherein the encryption key is different from the encryption secret.
17. The method of any of clauses 12-16, wherein the data as encrypted is not decrypted prior to being transmitted.
18. The method of any of clauses 12-17, wherein the encryption secret is a virtual trusted platform (vTPM) secret.
19. The method of any of clauses 12-18, wherein the encrypted storage device is a disk volume.
20. The method of any of clauses 12-19, further comprising receiving, at the primary site, the encryption secret from a first local secure store of the primary site, wherein the encryption secret is transmitted to the secondary site for encryption by a second local secure store of the secondary site.
21. The method of any of clauses 12-20, wherein the first local secure store is a key store.
22. The method of any of clauses 12-21, further comprising receiving, by a recovery service at the primary site, the encryption secret in encrypted form from a virtual machine (VM) service at the primary site, and sending the encryption secret to the first local secure store for decryption.
23. In some embodiments, a system comprises a primary computing device, memory storing instructions, and one or more processors coupled to the memory and, when executing the instructions, are configured to perform operations comprising transmitting, by the primary computing device, an encryption secret for an encrypted storage device to a secondary computing device, the encrypted storage device storing data encrypted based on the encryption secret, and transmitting, by the primary computing device using an unsecure channel, the data as encrypted based on the encryption secret to the secondary computing device.
24. The system of clause 23, wherein transmitting the encryption secret for the encrypted storage device to the secondary computing device is performed using a secure channel between the primary computing device and the secondary computing device.
25. The system of clauses 23 or 24, further comprising transmitting, by the primary computing device using the secure channel, a virtual machine configuration associated with the data as encrypted.
26. The system of any of clauses 23-25, wherein transmitting the encryption secret for the encrypted storage device to the secondary computing device further comprises encrypting the encryption secret using an encryption key associated with the primary computing device.
27. The system of any of clauses 23-26, wherein the encryption key is different from the encryption secret.
28. The system of any of clauses 23-27, wherein the data as encrypted is not decrypted prior to being transmitted.
29. The system of any of clauses 23-28, wherein the encryption secret is a virtual trusted platform (vTPM) secret.
30. The system of any of clauses 23-29, wherein the encrypted storage device is a disk volume.
31. The system of any of clauses 23-30, further comprising receiving, at the primary computing device, the encryption secret from a first local secure store of the primary computing device, wherein the encryption secret is transmitted to the secondary computing device for encryption by a second local secure store of the secondary computing device.
32. The system of any of clauses 23-31, wherein the first local secure store is a key store.
33. The system of any of clauses 23-32, further comprising receiving, by a recovery service at the primary computing device, the encryption secret in encrypted form from a virtual machine (VM) service at the primary computing device, and sending the encryption secret to the first local secure store for decryption.
34. In some embodiments, one or more non-transitory computer-readable media store program instructions that, when executed by one or more processors associated with a secondary computing device, cause the one or more processors to perform a method comprising securely receiving, by the secondary computing device, an encryption secret for an encrypted storage device from a primary computing device, the encrypted storage device storing data encrypted based on the encryption secret, and receiving, by the secondary computing device using an unsecure channel, the data as encrypted based on the encryption secret from the primary computing device.
35. The one or more non-transitory computer-readable media of clause 34, wherein securely receiving the encryption secret for the encrypted storage device from the primary computing device is performed using a secure channel between the primary computing device and the secondary computing device.
36. The one or more non-transitory computer-readable media of clauses 34 or 35, further comprising receiving, from the primary computing device using a secure channel, a virtual machine configuration associated with the data as encrypted.
37. The one or more non-transitory computer-readable media of any of clauses 34-36, wherein the encryption secret is encrypted using an encryption key associated with the primary computing device.
38. The one or more non-transitory computer-readable media of any of clauses 34-37, wherein the encryption key is different from the encryption secret.
39. The one or more non-transitory computer-readable media of any of clauses 34-38, wherein the data as encrypted is not decrypted prior to being received from the primary computing device.
40. The one or more non-transitory computer-readable media of any of clauses 34-39, wherein the encryption secret is a virtual trusted platform (vTPM) secret.
41. The one or more non-transitory computer-readable media of any of clauses 34-40, wherein the encrypted storage device is a disk volume.
42. The one or more non-transitory computer-readable media of any of clauses 34-41, wherein the encryption secret is encrypted using an encryption key prior to being received by the secondary computing device.
43. The one or more non-transitory computer-readable media of any of clauses 34-42, wherein the encryption key is received by a first local secure store of the secondary computing device from a second local secure store of the primary computing device.
44. The one or more non-transitory computer-readable media of any of clauses 34-43, wherein the first local secure store is a key store.
45. In some embodiments, a method comprises securely receiving, by a secondary site, an encryption secret for an encrypted storage device from a primary site, the encrypted storage device storing data encrypted based on the encryption secret, and receiving, by the secondary site using an unsecure channel, the data as encrypted based on the encryption secret from the primary site.
46. The method of clause 45, wherein securely receiving the encryption secret for the encrypted storage device from the primary site is performed using a secure channel between the primary site and the secondary site.
47. The method of clauses 45 or 46, further comprising receiving, from the primary site using a secure channel, a virtual machine configuration associated with the data as encrypted.
48. The method of any of clauses 45-47, wherein the encryption secret is encrypted using an encryption key associated with the primary site.
49. The method of any of clauses 45-48, wherein the encryption key is different from the encryption secret.
50. The method of any of clauses 45-49, wherein the data as encrypted is not decrypted prior to being received from the primary site.
51. The method of any of clauses 45-50, wherein the encryption secret is a virtual trusted platform (vTPM) secret.
52. The method of any of clauses 45-51, wherein the encrypted storage device is a disk volume.
53. The method of any of clauses 45-52, wherein the encryption secret is encrypted using an encryption key prior to being received by the secondary site.
54. The method of any of clauses 45-53, wherein the encryption key is received by a first local secure store of the secondary site from a second local secure store of the primary site.
55. The method of any of clauses 45-54, wherein the first local secure store is a key store.
56. In some embodiments, a system comprises a secondary computing device, memory storing instructions, and one or more processors coupled to the memory and, when executing the instructions, are configured to perform operations comprising securely receiving, by the secondary computing device, an encryption secret for an encrypted storage device from a primary computing device, the encrypted storage device storing data encrypted based on the encryption secret, and receiving, by the secondary computing device using an unsecure channel, the data as encrypted based on the encryption secret from the primary computing device.
57. The system of clause 56, wherein securely receiving the encryption secret for the encrypted storage device from the primary computing device is performed using a secure channel between the primary computing device and the secondary computing device.
58. The system of clauses 56 or 57, further comprising receiving, from the primary computing device using a secure channel, a virtual machine configuration associated with the data as encrypted.
59. The system of any of clauses 56-58, wherein the encryption secret is encrypted using an encryption key associated with the primary computing device.
60. The system of any of clauses 56-59, wherein the encryption key is different from the encryption secret.
61. The system of any of clauses 56-60, wherein the data as encrypted is not decrypted prior to being received from the primary computing device.
62. The system of any of clauses 56-61, wherein the encryption secret is a virtual trusted platform (vTPM) secret.
63. The system of any of clauses 56-62, wherein the encrypted storage device is a disk volume.
64. The system of any of clauses 56-63, wherein the encryption secret is encrypted using an encryption key prior to being received by the secondary computing device.
65. The system of any of clauses 56-64, wherein the encryption key is received by a first local secure store of the secondary computing device from a second local secure store of the primary computing device.
66. The system of any of clauses 56-65, wherein the first local secure store is a key store.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. One or more non-transitory computer-readable media storing program instructions that, when executed by one or more processors associated with a primary site, cause the one or more processors to perform a method comprising:
transmitting, by the primary site, an encryption secret for an encrypted storage device to a secondary site, the encrypted storage device storing data encrypted based on the encryption secret; and
transmitting, by the primary site using an unsecure channel, the data as encrypted based on the encryption secret to the secondary site.

2. The one or more non-transitory computer-readable media of claim 1, wherein transmitting the encryption secret for the encrypted storage device to the secondary site is performed using a secure channel between the primary site and the secondary site.

3. The one or more non-transitory computer-readable media of claim 2, further comprising transmitting, by the primary site using the secure channel, a virtual machine configuration associated with the data as encrypted.

4. The one or more non-transitory computer-readable media of claim 1, wherein transmitting the encryption secret for the encrypted storage device to the secondary site further comprises encrypting the encryption secret using an encryption key associated with the primary site.

5. The one or more non-transitory computer-readable media of claim 4, wherein the encryption key is different from the encryption secret.

6. The one or more non-transitory computer-readable media of claim 1, wherein the data as encrypted is not decrypted prior to being transmitted.

7. The one or more non-transitory computer-readable media of claim 1, wherein the encryption secret is a virtual trusted platform (vTPM) secret.

8. The one or more non-transitory computer-readable media of claim 1, wherein the encrypted storage device is a disk volume.

9. The one or more non-transitory computer-readable media of claim 1, further comprising receiving, at the primary site, the encryption secret from a first local secure store of the primary site, wherein the encryption secret is transmitted to the secondary site for encryption by a second local secure store of the secondary site.

10. The one or more non-transitory computer-readable media of claim 9, wherein the first local secure store is a key store.

11. The one or more non-transitory computer-readable media of claim 9, further comprising:
receiving, by a recovery service at the primary site, the encryption secret in encrypted form from a virtual machine (VM) service at the primary site; and
sending the encryption secret to the first local secure store for decryption.

12. A method comprising:
transmitting, by a primary site, an encryption secret for an encrypted storage device to a secondary site, the encrypted storage device storing data encrypted based on the encryption secret; and
transmitting, by the primary site using an unsecure channel, the data as encrypted based on the encryption secret to the secondary site.

13. The method of claim 12, wherein transmitting the encryption secret for the encrypted storage device to the secondary site is performed using a secure channel between the primary site and the secondary site.

14. The method of claim 13, further comprising transmitting, by the primary site using the secure channel, a virtual machine configuration associated with the data as encrypted.

15. The method of claim 12, wherein transmitting the encryption secret for the encrypted storage device to the secondary site further comprises encrypting the encryption secret using an encryption key associated with the primary site.

16. The method of claim 15, wherein the encryption key is different from the encryption secret.

17. The method of claim 12, wherein the data as encrypted is not decrypted prior to being transmitted.

18. The method of claim 12, wherein the encryption secret is a virtual trusted platform (vTPM) secret.

19. The method of claim 12, wherein the encrypted storage device is a disk volume.

20. The method of claim 12, further comprising receiving, at the primary site, the encryption secret from a first local secure store of the primary site, wherein the encryption secret is transmitted to the secondary site for encryption by a second local secure store of the secondary site.

21. The method of claim 20, wherein the first local secure store is a key store.

22. The method of claim 20, further comprising:
receiving, by a recovery service at the primary site, the encryption secret in encrypted form from a virtual machine (VM) service at the primary site; and
sending the encryption secret to the first local secure store for decryption.

23. A system comprising:
a primary computing device;
memory storing instructions; and
one or more processors coupled to the memory and, when executing the instructions, are configured to perform operations comprising:
transmitting, by the primary computing device, an encryption secret for an encrypted storage device to a secondary computing device, the encrypted storage device storing data encrypted based on the encryption secret; and
transmitting, by the primary computing device using an unsecure channel, the data as encrypted based on the encryption secret to the secondary computing device.

24. The system of claim 23, wherein transmitting the encryption secret for the encrypted storage device to the secondary computing device is performed using a secure channel between the primary computing device and the secondary computing device.

25. The system of claim 24, further comprising transmitting, by the primary computing device using the secure channel, a virtual machine configuration associated with the data as encrypted.

26. The system of claim 23, wherein transmitting the encryption secret for the encrypted storage device to the secondary computing device further comprises encrypting the encryption secret using an encryption key associated with the primary computing device.

27. The system of claim 26, wherein the encryption key is different from the encryption secret.

28. The system of claim 23, wherein the data as encrypted is not decrypted prior to being transmitted.

29. The system of claim 23, wherein the encryption secret is a virtual trusted platform (vTPM) secret.

30. The system of claim 23, wherein the encrypted storage device is a disk volume.

31. The system of claim 23, further comprising receiving, at the primary computing device, the encryption secret from a first local secure store of the primary computing device, wherein the encryption secret is transmitted to the secondary computing device for encryption by a second local secure store of the secondary computing device.

32. The system of claim 31, wherein the first local secure store is a key store.

33. The system of claim 31, further comprising:
receiving, by a recovery service at the primary computing device, the encryption secret in encrypted form from a virtual machine (VM) service at the primary computing device; and
sending the encryption secret to the first local secure store for decryption.
